(19) United States
(12) Patent Application Publication
(10) Pub. No.: US 2006/0132052 A1
(43) Pub. Date: Jun. 22, 2006

(54) Electron-emitting apparatus and method for emitting electrons

(75) Inventors: Iwao Ohwada, Nagoya-city (JP); Takayoshi Akao, Nagoya-city (JP); Naoki Goto, Ohgaki-city (JP); Tomohiko Sugiyama, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/229,038

(22) Filed: Sep. 16, 2005

(30) Foreign Application Priority Data
Oct. 14, 2004 (JP) 2004-300392
Feb. 15, 2005 (JP) 2005-038151

(51) Int. Cl. G09G 3/10

(52) U.S. Cl. 315/169.3

(57) ABSTRACT

An electron-emitting apparatus includes an electron-emitting element having a lower electrode, an emitter section having a dielectric material, and a plurality of upper electrodes having micro through holes, and a drive voltage applying circuit having a circuit for applying a drive voltage Vin between the lower electrode and the upper electrode. The drive voltage applying circuit applies a drive voltage between the lower electrode and the upper electrode to set an element voltage Vka, which is a potential of the upper electrode relative to a potential of the lower electrode, at a negative voltage for a charge accumulation period Td so as to accumulate electrons in the emitter section, and to set the element voltage Vka at a predetermined positive voltage for an electron emission period Th so as to emit electrons from the emitter section. Further, the drive voltage applying circuit stepwise increases the positive voltage for the electron emission period Th and separately emits the electrons accumulated in the emitter section a plurality of times.

### TECHNICAL FIELD

The present invention relates to an electron-emitting apparatus (device) comprising an element having an emitter section made of a dielectric material, a lower electrode disposed below the emitter section, and an upper electrode disposed above the emitter section and an electron-emitting method using the element.

### BACKGROUND ART

Conventionally, an electron-emitting apparatus is known that comprises an electron-emitting element including an emitter section made of a dielectric material, a lower electrode (lower electrode layer) disposed below the emitter section, and an upper electrode (upper electrode layer) disposed above the emitter section and having numerous micro through holes. In the electron-emitting apparatus, a drive voltage is applied between the upper electrode and the lower electrode to reverse the polarization of the dielectric material and to thereby emit electrons through the micro through holes in the upper electrode (e.g., refer to Japanese Unexamined Patent Application Publication No. 2005-183361).

In the electron-emitting device, upon setting the potential of the upper electrode with respect to the potential of the lower electrode (i.e., the potential difference between the lower electrode and the upper electrode with the potential of the lower electrode as the reference, hereinafter, also referred to as “element voltage”) to a negative voltage whose absolute value is larger than a predetermined level, electrons are supplied from the upper electrode to the emitter section, thus to accumulate the electrons to the emitter section. Further, upon setting the element voltage to the positive voltage whose absolute value is larger than another predetermined level when electrons are accumulated in the emitter section, the electrons accumulated in the emitter section are emitted in the upward direction of the upper electrode via the micro through holes.

Specifically, referring to FIG. 24, a drive voltage Vin applied between the upper electrode and the lower electrode is set to the negative voltage Vm1 during a charge accumulation period Td. Thus, the electrons are accumulated in the emitter portion. Subsequently, the drive voltage Vin is changed to set the element voltage to the positive voltage Vp1 during an electron-emission period Th. Thus, as shown by current Ph of emitted electrons in FIG. 24, the electrons accumulated in the emitter section are emitted in the upward direction of the upper electrode.

### DISCLOSURE OF INVENTION

The above-mentioned electron-emitting apparatus is used as a display, a backlight of a liquid crystal screen, or, various electron-emitting sources. Therefore, it is preferable that the amount of emitted electrons (e.g., expressed as an area SI shaded in FIG. 24) be large during a predetermined period T.

In order to increase the amount of emitted electrons within the predetermined period T, the charge accumulation period Td and electron-emission period Th are set to be short, thereby increasing the number of electron-emitting times during the predetermined period T, as shown in FIG. 25. However, according to this method, the increase in number of polarization reversal time of the electron-emitting element may reduce the lifetime of electron emitting element.

On the other hand, as shown in FIG. 26, in order to increase the amount of emitted electrons within the predetermined period T, the negative voltage may be changed from Vm1 to Vm2 (|Vm2|>|Vm1|) to increase the amount of accumulated electrons once. Further, the positive voltage may be changed from Vp1 to Vp2 (|Vp2|>|Vp1|) to increase the amount of emitted electrons per one emission (expressed by an area S2 corresponding to a shaded portion in FIG. 26). However, according to this method, a peak value Pk2 of the current of emitted electrons shown in FIG. 26 is larger than a peak value Pk1 shown in FIG. 24. Thus, as will be obviously understood, a large amount of electrons are emitted within a short time period (during the operation for emitting electrons once). As a result, inrush current flows through the electron-emitting element, thereby to generate a large amount of heat. Thus, the element may be deteriorated.

The present invention is devised to solve the above-mentioned problems. It is one of objects of the present invention to provide an electron-emitting apparatus having the long lifetime and capable of emitting a large amount of electrons, and an electron-emitting method by which the amount of emitted electrons increases while avoiding the deterioration in lifetime of electron-emitting element.

In order to accomplish the above-mentioned object, an electron-emitting apparatus according to the present invention comprises an element (an electron-emitting element) including: an emitter section made of a dielectric material; a lower electrode disposed below the emitter section; and an upper electrode disposed above the emitter section to oppose the lower electrode with the emitter section sandwiched therebetween, the upper electrode having a plurality of micro through holes and formed in such a manner that its surface around the circumference of the micro through holes facing the emitter section is apart from the emitter section.

The element supplies electrons to the emitter section from the upper electrode when an element voltage (said element voltage), as a potential of the upper electrode relative to a potential of the lower electrode, is a negative voltage whose absolute value is larger than a predetermined level, and accumulates the electrons in the emitter section. Further, the element emits the electrons accumulated in the emitter section via the micro through holes when the element voltage is a positive voltage whose absolute value is larger than another predetermined level while the electrons are accumulated (i.e., stored or held) in the emitter section.

Furthermore, the electron-emitting apparatus according to the present invention comprises drive voltage applying means for applying a drive voltage between the upper electrode and the lower electrode to set the element voltage to the negative voltage and thereafter to set the element voltage to the positive voltage. The drive voltage applying means increases the positive voltage stepwise (for example, refer to FIG. 15).

Thus, upon setting the element voltage to the negative voltage, electrons are accumulated in the emitter section. Then, the accumulated electrons are gradually emitted at each time of stepwise increase in element voltage.

In other words, the electrons which was accumulated in the emitter section by one electron-accumulation operation are emitted via the micro through holes of the upper electrode a plurality of times (the electrons are emitted a plurality of times by an divided amount). Therefore, even if the level of the negative voltage is larger and thus a large amount of electrons are accumulated in the emitter section (e.g., in the case of setting the negative voltage to a voltage Vm2), the amount of emitted electrons per a single electron-emission operation (i.e., per each emission) is smaller than that in the conventional case shown in FIG. 26 (that is, peak value Pk3 of the current of emitted electrons<peak value Pk2 of the current of emitted electrons). As a result, since the large inrush current flowing locally through the electron-emitting element is prevented, the deterioration in element due to the heating is avoided and the amount of emitted electrons for the predetermined period T is increased. Further, the dipoles in the emitter section rotates only once during a period from the one (once) electron-accumulation to the emission of electrons accumulated by the electron accumulation. Therefore, since the number of times for polarization reversal of the dipoles is not increased, the deterioration in element is suppressed.

In this case, preferably, the drive voltage applying means temporarily sets the element voltage to a voltage which is smaller than a first voltage and which does not cause the element to accumulate electrons in the emitter section, upon stepwise increasing the positive voltage from the first voltage to a second voltage which is larger than the first voltage (for example, refer to FIG. 17).

By the configuration above, it becomes possible to certainly provide a period for preventing (stopping) the electron-emission between two successive (continuous) electron-emission periods. As a consequence, the electrons can be emitted at the timing corresponding to the request of a display to which the electron-emitting apparatus is applied. In other words, the frequency for electron emission can be substantially increased.

Note that the number of steps is not limited in (when) stepwise changing the positive voltage. Therefore, for example, the element voltage may be increased from the first voltage to the second voltage, then, it may be increased from the second voltage to a third voltage which is larger than the second voltage, and, it may be thereafter changed to the negative voltage.

An electron-emitting method using the above described electron-emitting element according to the present invention comprises a step of setting, to a negative voltage, an element voltage which is a potential of the upper electrode relative to a potential of the lower electrode, for supplying electrons to the emitter section from the upper electrode to accumulate the electrons to the emitter section, thereafter increasing the element voltage to a first positive voltage to emit via the micro through holes the electrons accumulated in the emitter section, then increasing the element voltage to a second positive voltage larger than the first voltage to emit via the micro through hole the electrons remaining in the emitter section.

By the method above, similarly to the electron-emitting apparatus according to the present invention, the electrons which were accumulated in the emitter section by one electron-accumulation operation are emitted via the micro through holes of the upper electrode a plurality of times separately. Thus, based on the above-mentioned reason, the amount of emitted electrons for a predetermined period T is increased while avoiding the deterioration in element due to the heating and due to the increase in number of polarization reversal times.

Further, in this case, it is also preferable that the element voltage be temporarily set to (at) a voltage which is smaller than a first voltage and which does not cause the element to accumulate electrons in the emitter section, upon stepwise increasing the positive voltage from the first voltage to a second voltage which is larger than the first voltage.

With the feature above, it becomes possible to certainly provide a period for preventing (stopping) the electron-emission between two successive (continuous) electron-emission periods. Therefore, the electrons can be emitted at the timing corresponding to various requests.

Further, the electron-emitting apparatus according to the present invention or the element to which the electron-emitting method according to the present invention is applied, preferably, comprises a phosphor which emits light by electron collision and which is disposed in the upper side of the upper electrode to oppose the upper electrode.

In general, if and when an excessively large amount of electrons collide with the phosphor, the energy of the electrons changes to the heat and thus the amount of emission light from the phosphor is not increased. After ending the collision of electrons, the phosphor emits light (remaining light) whose amount decreases in accordance with the time elapse. Therefore, the phosphor can emit light with high efficiency, if electrons whose amount is proper in that energy of the electrons does not change to the heat are caused to collide with the phosphor, then, the collision of electrons is stopped, and then electrons are caused to collide with the phosphor again at the proper timing when an amount of light (remaining light) becomes small.

Therefore, as the electron-emitting apparatus or the electron-emitting method, according to the present invention, a large amount of emission light is generated with small power-consumption by repeating the electron emission for a short period a plurality of times and causing the emitted electrons to collide with the phosphor, while suppressing an amount of emitted electrons for each of the electron emissions. As a result, it is possible to provide a display device showing a clear image with lower power-consumption or a light-emitting device capable of emitting a large amount of light.

In this case, preferably, the electron-emitting element used by the electron-emitting apparatus or the electron-emitting method further comprises:

a collector electrode disposed near the phosphor; and

collector voltage applying means for applying a voltage to the collector electrode so that the collector electrode generates an electric field which attracts the emitted electrons to the collector electrode side.

With this configuration, the electric field generated by the collector electrode can certainly cause the electrons emitted from the emitter section via the micro through holes of the upper electrode to collide with the phosphor. Further, the electric field generated by the collector electrode accelerates the electrons by applying the energy to the emitted electrons, thereby increasing the amount of emission light of the phosphor.

### BRIEF DESCRIPTION OF THE DRAWINGS

FIG. 1 is a partial cross-sectional view showing an electron-emitting apparatus according to a first embodiment of the present invention;

FIG. 2 is a partial cross-sectional view showing the electron-emitting apparatus shown in FIG. 1, taken along a different plane;

FIG. 3 is a partial plan view showing the electron-emitting apparatus shown in FIG. 1;

FIG. 4 is an enlarged partial cross-sectional view showing the electron-emitting apparatus shown in FIG. 1;

FIG. 5 is an enlarged partial plan view showing an upper electrode shown in FIG. 1;

FIG. 6 is a diagram showing one state showing the electron-emitting apparatus shown in FIG. 1;

FIG. 7 is a graph showing the voltage-polarization characteristic of an emitter section shown in FIG. 1;

FIG. 8 is a diagram showing another state of the electron-emitting apparatus shown in FIG. 1;

FIG. 9 is a diagram showing another state of the electron-emitting apparatus shown in FIG. 1;

FIG. 10 is a diagram showing another state of the electron-emitting apparatus shown in FIG. 1;

FIG. 11 is a diagram showing another state of the electron-emitting apparatus shown in FIG. 1;

FIG. 12 is a diagram showing another state of the electron-emitting apparatus shown in FIG. 1;

FIG. 13 is a diagram showing a state of electrons emitted from an electron-emitting apparatus having no focusing electrode;

FIG. 14 is a diagram showing a state of electrons emitted from the electron-emitting apparatus shown in FIG. 1;

FIG. 15 is a time chart showing a drive voltage applied between the upper and lower electrodes by a drive voltage applying circuit shown in FIG. 1 and the current of emitted electrons indicating the amount of emitted electrons;

FIG. 16 is a circuit diagram showing the drive voltage applying circuit shown in FIG. 1, a focusing electrode potential applying circuit, and a collector voltage applying circuit;

FIG. 17(A) is a time chart showing a drive voltages applied between upper and lower electrodes by a drive voltage applying circuit in an electron-emitting apparatus according to a second embodiment of the present invention and the current of emitted electrons indicating the amount of emitted electrons;

FIG. 17(B) is a graph showing the voltage-polarization characteristic of an emitter section;

FIG. 18 is a time chart showing a drive voltage applied between upper and lower electrodes by a drive voltage applying circuit in an electron-emitting apparatus and the current of emitted electrons indicating the amount of emitted electrons according to a third embodiment of the present invention;

FIG. 19 is a partial cross-sectional view showing an electron-emitting apparatus according to a fourth embodiment of the present invention;

FIG. 20 is a partial plan view of one modification of the electron-emitting apparatus according to the present invention;

FIG. 21 is a partial plan view showing another modification of the electron-emitting apparatus according to the present invention;

FIG. 22 is a partial cross-sectional view showing still another modification of the electron-emitting apparatus according to the present invention;

FIG. 23 is another partial cross-sectional view showing the electron-emitting apparatus shown in FIG. 22;

FIG. 24 is a time chart showing a drive voltage applied between upper and lower electrodes in a conventional electron-emitting apparatus and the current of emitted electrons indicating the amount of emitted electrons;

FIG. 25 is a time chart showing another drive voltage applied between the upper and lower electrodes in the conventional electron-emitting device and the current of emitted electrons indicating the amount of emitted electrons; and

FIG. 26 is a time chart showing still another drive voltage applied between the upper and lower electrodes in the conventional electron-emitting device and the current of emitted electrons indicating the amount of emitted electrons.

### BEST MODE FOR CARRYING OUT THE INVENTION

Electron-emitting apparatuses and electron-emitting methods according to the embodiments of the present invention will now be described with reference to the drawings. The electron-emitting apparatus is applicable to electron beam irradiators, light sources, such as a backlight of a liquid crystal screen, electron-emitting sources of manufacturing apparatuses for electronic components, and the like. Note that in the description below, the electron-emitting apparatuses are applied to displays.

### First Embodiment

(Structure)

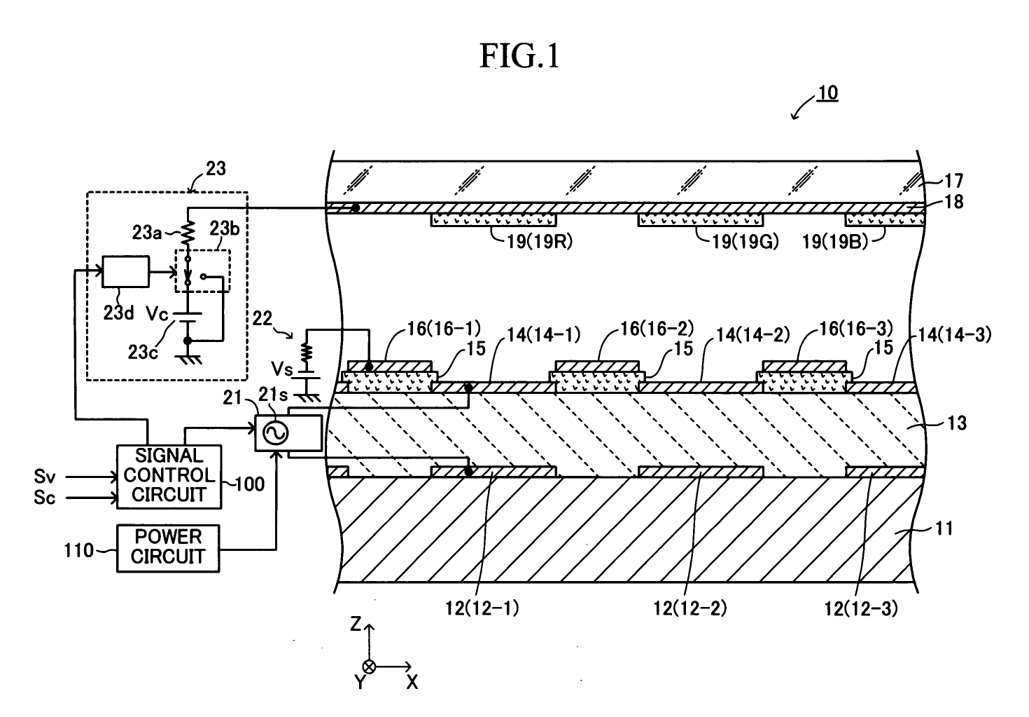

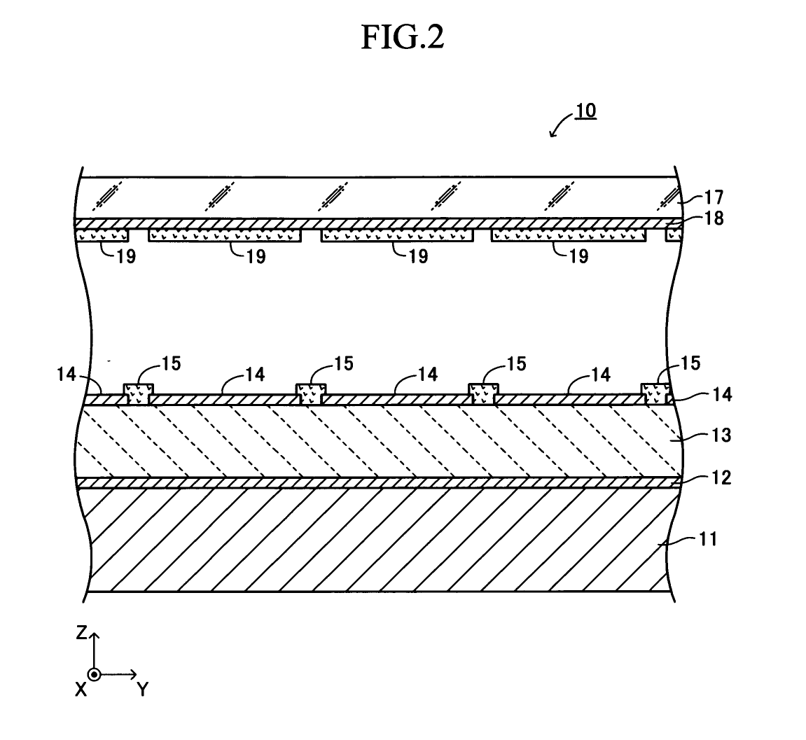

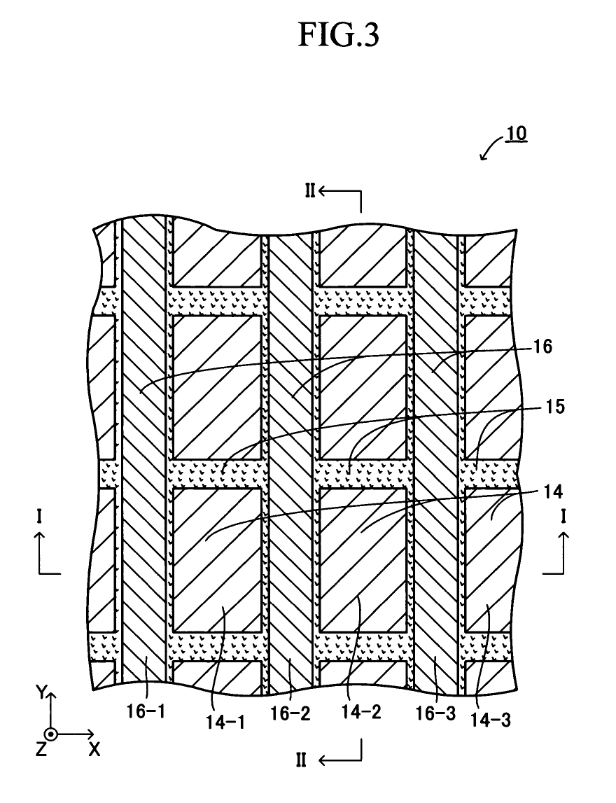

As shown in FIGS. 1 to 3, an electron emitting apparatus 10 according to a first embodiment of the present invention comprises: a substrate 11; a plurality of lower electrodes (lower electrode layers) 12; an emitter section 13; a plurality of upper electrodes (upper electrode layers) 14; an insulating layers 15; and a plurality of focusing electrodes (focusing electrode layers) 16. FIG. 1 is a cross-sectional view showing the electron-emitting apparatus 10 taken along a line l-I in FIG. 3, which is a partial plan view showing the electron-emitting apparatus 10. FIG. 2 is a cross-sectional view showing the electron-emitting apparatus 10 taken by a plane along a line II-II in FIG. 3.

The substrate 11 is a thin plate having an upper surface and a lower surface parallel to the plane (X-Y plane) defined by the X axis and the Y axis perpendicular to each other. The thickness direction of the substrate 11 is the Z-axis direction perpendicular to both the X and Y axes. The substrate 11 is made of, e.g., glass or ceramics (preferably, a material containing zirconium oxide as a main component).

Each of the lower electrodes 12 is a layer made of a conductive material, e.g., silver or platinum in this embodiment, and is disposed (formed) on the upper surface of the substrate 11. In a plan view, each lower electrode 12 has a shape of a strip. The longitudinal direction of the strip is the Y-axis direction. As shown in FIG. 1, the adjacent two lower electrodes 12 are apart from each other by a predetermined distance in the X-axis direction. Note that in FIG. 1, the lower electrodes 12 represented by reference numerals 12-1, 12-2, and 12-3 are respectively referred to as a first lower electrode, a second lower electrode, and a third lower electrode for the convenience sake.

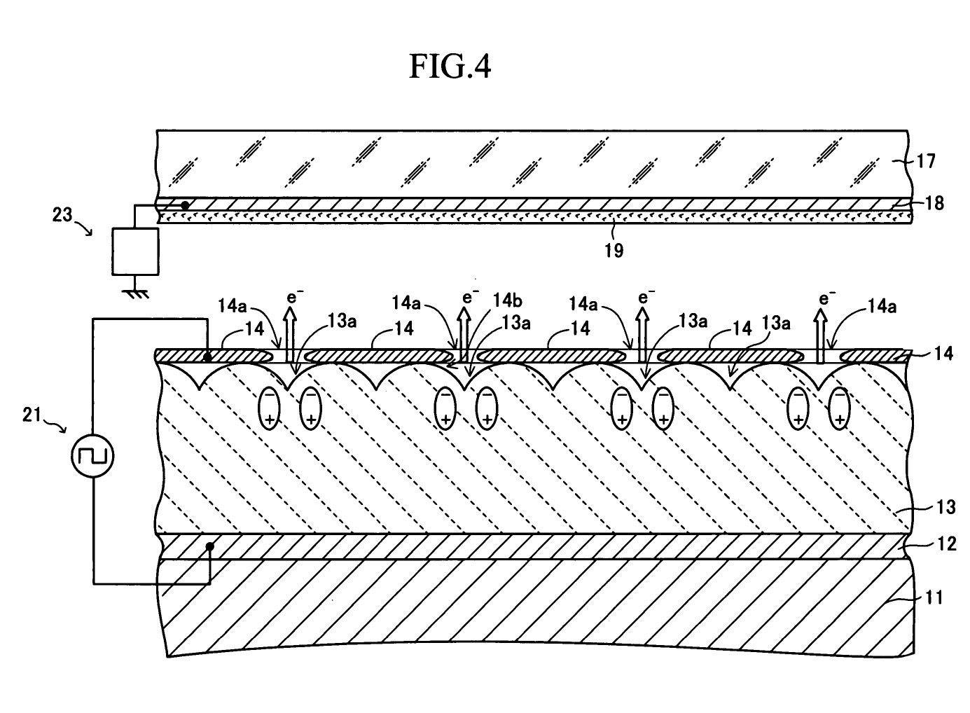

The emitter section 13 is made of a dielectric material having a high relative dielectric constant (for example, a three-component material PMN-PT-PZ composed of lead magnesium niobate (PMN), lead titanate (PT), and lead zirconate (PZ), and materials for the emitter section 13 will be described in detail below). The emitter section 13 is formed on the upper surfaces of the substrate 11 and lower electrodes 12. The emitter section 13 is a thin plate similar to the substrate 11. As shown in an enlarged view in FIG. 4, the upper surface of the emitter section 13 has irregularities (asperities) 13a formed by the grain boundaries of the dielectric material.

Each of the upper electrodes 14 is a layer made of a conductive material, e.g., platinum in this embodiment, and is formed on the upper surface of the emitter section 13. As shown in a plan view of FIG. 3, each upper electrode 14 has a shape of a rectangle having a short side and a long side respectively lying in the X-axis direction and the Y-axis direction. The upper electrodes 14 are apart from one another and are disposed (arranged) into a matrix. Each upper electrode 14 is opposed to the corresponding lower electrode 12. In a plan view, the upper electrode 14 is disposed at a position that overlaps the corresponding lower electrode 12.

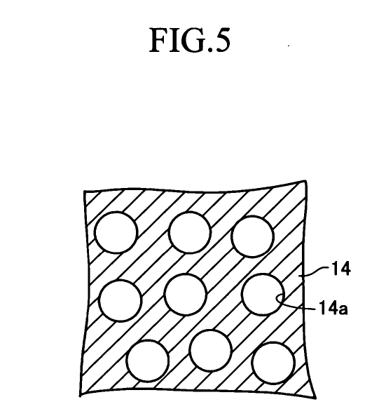

Furthermore, as shown in FIGS. 4 and 5, which is a partial enlarged view of the upper electrode 14, each upper electrode 14 has a plurality of micro through holes 14a. Note that in FIGS. 1 and 3, the upper electrodes 14 represented by reference numerals 14-1, 14-2, and 14-3 are respectively referred to as a first upper electrode, a second upper electrode, and a third upper electrode for the convenience sake. The upper electrodes 14 aligned in the same row with respect to the X-axis direction (i.e., in the same row extending along the Y-axis direction) are connected to one another by a layer (not shown) made of a conductor and are maintained at the same electric potential. The surface of the upper electrodes 14 to oppose the emitter section 13 at the circumference of a micro through hole 14a is apart from the emitter section 13 (i.e., upper surface of the emitter section 13), as shown by reference numeral 14b in FIG. 4.

The lower electrodes 12, the emitter section 13, and the upper electrodes 14 made of a platinum resinate paste are monolithically integrated by firing (baking). As a result of the firing for integration, the upper electrode 14 shrinks and its thickness of the upper electrode 14 reduces, for example, from 10 μm to 0.1 μm. Upon this shrinking, the micro through holes 14a are formed in the upper electrode 14. Note that the average diameter of the micro through holes 14a may be not less than 0.01 μm and not more than 10 μm.

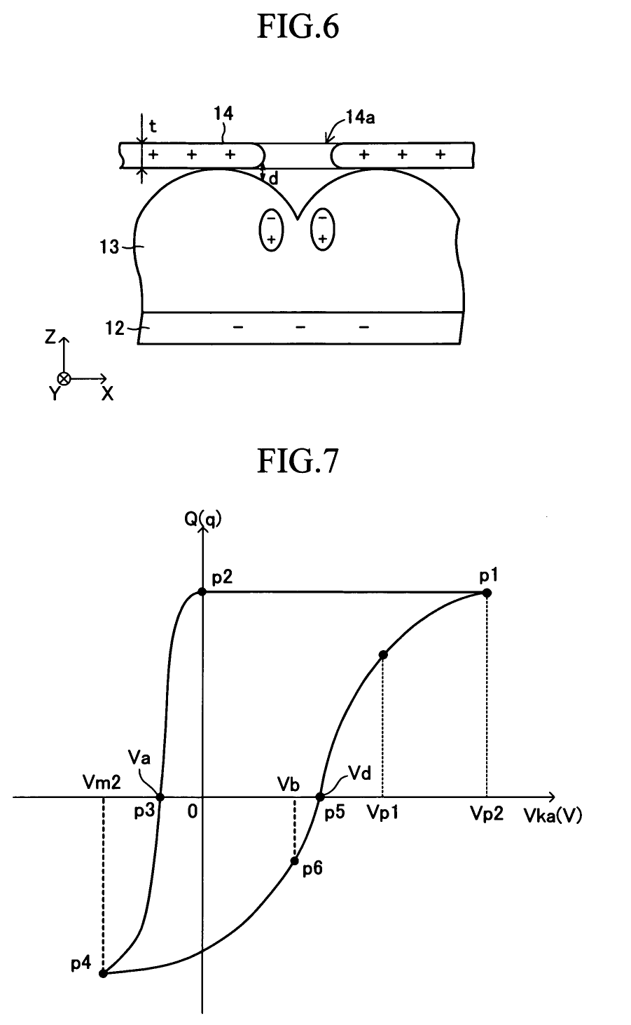

As shown in FIG. 6, a thickness t of the upper electrode 14 is 0.01 μm or more and 10 μm or less. Preferably, the thickness t is 0.05 μm or more and 1 μm or less. Further, a maximum d of the distance between the emitter section 13 (upper surface of the upper electrode 13) and the surface facing the emitter section 13 at the circumference of the through hole 14a (end of the through hole) is larger than 0 μm and 10 μm or less. Preferably, the maximum d is 0.01 μm or more and 1 μm or less.

As described above, the portion where an upper electrode 14 overlaps the lower electrode 12 in a plan view forms one (single) element for emitting electrons. For example, the first lower electrode 12-1, the first upper electrode 14-1, and the portion of the emitter section 13 sandwiched between the first lower electrode 12-1 and the first upper electrode 14-1 form a first element. The second lower electrode 12-2, the second upper electrode 14-2, and the portion of the emitter section 13 sandwiched between the second lower electrode 12-2 and the second upper electrode 14-2 form a second element. The third lower electrode 12-3, the third upper electrode 14-3, and the portion of the emitter section 13 sandwiched between the third lower electrode 12-3 and the third upper electrode 14-3 form a third element. In this manner, the electron-emitting apparatus 10 includes a plurality of independent electron-emitting elements.

The insulating layers 15 are disposed (formed) on the upper surface of the emitter section 13 so as to fill the gaps between the upper electrodes 14. The thickness (the length in the Z-axis direction) of each insulating layer 15 is slightly larger than the thickness (the length in the Z-axis direction) of each upper electrode 14. As shown in FIGS. 1 and 2, the end portions of each insulating layer 15 in the X-axis direction and the Y-axis direction cover the end portions of the upper electrodes 14 in the X-axis and Y-axis directions, respectively.

Each of the focusing electrodes 16 is a layer made of a conductive material, e.g., silver in this embodiment, and are disposed (formed) on each of the insulating layers 15. As shown in a plan view of FIG. 3, each focusing electrode 16 has a shape of a strip whose longitudinal direction is the Y-axis direction. Each focusing electrode 16 is disposed (formed) between the adjacent upper electrodes 14 in the X-axis direction in the plan view. Each focusing electrode 16 is disposed between the upper electrodes of the elements adjacent to each other in the X-axis direction and is slightly obliquely above the upper electrodes. All the focusing electrodes 16 are connected to one another by a layer (not shown) made of a conductor and maintained at the same potential.

In FIGS. 1 and 3, the focusing electrodes 16 represented by reference numerals 16-1, 16-2, and 16-3 are respectively referred to as a first focusing electrode, a second focusing electrode, and a third focusing electrode for the convenience sake. The second focusing electrode 16-2 lies between the first upper electrode 14-1 of the first element and the second upper electrode 14-2 of the second element and is located obliquely above the first and second upper electrodes 14-1 and 14-2. Similarly, the third focusing electrode 16-3 is between the second upper electrode 14-2 of the second element and the third upper electrode 14-3 of the third element and is located obliquely above the second and third upper electrodes 14-2 and 14-3.

The electron emitting apparatus 10 further comprises: a transparent plate 17; a collector electrode (collector electrode layer) 18; and phosphors 19.

The transparent plate 17 is made of a transparent material (e.g., glass or acrylic resin in this embodiment), and is disposed above the upper electrodes 14 so that the transparent plate 17 is apart from the upper electrodes 14 in the positive direction of the Z axis by a predetermined distance. The upper and lower surfaces of the transparent plate 17 are parallel to the upper surfaces of the emitter section 13 and the upper electrodes 14 (i.e., the upper and lower surfaces lie in the X-Y plane).

The collector electrode 18 is made of a conductive material (e.g., in this embodiment, a transparent conductive film made of indium tin oxide (ITO)) and is formed as a layer covering the entire lower surface of the transparent plate 17. In other words, the collector electrode 18 is disposed above the upper electrodes 14 to be opposed to the upper electrodes 14 apart from the upper electrode 14 for a predetermined distance.

Each phosphor 19 enters the exciting state by the collision of electrons, and emits red, green, or blue light in the transition from the exciting state to the base state. In a plan view, each phosphor 19 has substantially the same shape as that of the upper electrode 14 and overlaps the corresponding upper electrode 14. In FIG. 1, the phosphors 19 represented by reference numerals 19R, 19G, and 19B respectively emit red, green, and blue light. In this embodiment, the red phosphor 19R is disposed directly above the first upper electrode 14-1 (i.e., in the positive direction of the Z axis), the green phosphor 19G is disposed directly above the second upper electrode 14-2, and the blue phosphor 19B is disposed directly above the third upper electrode 14-3.

For example, the red phosphor may be made of Y₂O₂S:Eu, the green phosphor may be made of ZnS:Cu and Al, and the blue phosphor may be made of ZnS:Ag and Cl. Further, if the phosphor 19 is made of Y₂O₂S:Tb, a white phosphor which emits white light can be obtained. Or, the white phosphor can be manufactured by mixing the red phosphor (e.g., Y₂O₂S:Eu), the green phosphor (e.g., ZnS:Cu and Al), and the blue phosphor (e.g., ZnS:Ag and C1).

The space surrounded by the emitter section 13, the upper electrodes 14, the insulating layers 15, the focusing electrodes 16, and the transparent plate 17 (the collector electrode 18) is maintained under substantial vacuum of preferably 10² to 10⁻⁶ Pa and more preferably 10⁻³ to 10⁻⁵ Pa. In other words, the side walls (not shown) of the electron emitting apparatus 10, the transparent plate 17, and the collector electrode 18 serve as the members for defining a hermetically closed space, and this hermetically closed space is maintained under substantial vacuum. The elements (at least the upper part of the emitter section 13 and the upper electrode 14 of each element) of the electron emitting apparatus 10 are disposed inside the hermetically closed space under substantial vacuum.

As shown in FIG. 1, the electron emitting apparatus 10 further comprises a drive voltage applying circuit (drive voltage applying means or potential difference applying means) 21, a focusing electrode potential applying circuit (focusing electrode potential difference applying means) 22, and a collector voltage applying circuit (collector voltage applying means) 23.

The drive voltage applying circuit 21 includes a power supply 21s which generates a drive voltage Vin (which will be described later). The power supply 21s is connected to the upper electrodes 14 and the lower electrodes 12. In other words, the drive voltage applying circuit 21 comprises the power supply 21s and a circuit for connecting the power supply 21s to each of the elements. Further, the drive voltage applying circuit 21 is connected to a signal control circuit 100 and a power circuit 110. The drive voltage applying circuit 21 applies the drive voltage Vin (to the element) between the lower electrode 12 and the upper electrode 14 facing to each other, based on the signal received from the signal control circuit 100.

The focusing electrode potential applying circuit 22 is connected to the focusing electrodes 16 and constantly applies a predetermined negative potential (voltage) Vs to the focusing electrodes 16.

The collector voltage applying circuit 23 applies a predetermined voltage (collector voltage) to the collector electrode 18 and includes a resistance 23a, a switching element 23b, a constant voltage source 23c, and a switch control circuit 23d. One end of the resistance 23a is connected to the collector electrode 18. The other end of the resistance 23a is connected to a fixed connection point of the switching element 23b. The switching element 23b is a semiconductor element, such as MOS-FET, and is connected to the switch control circuit 23d.

The switching element 23b has two switching points in addition to the above-described fixed connection point. In response to the control signal from the switch control circuit 23d, the switching element 23b selectively couples the fixed connection point to one of the two switching points. One of the two switching points is grounded, and the other is connected to the anode of the constant voltage source 23c. The cathode of the constant voltage source 23c is grounded. The switch control circuit 23d is connected to the signal control circuit 100, and controls the switching operation of the switching element 23b based on the signal received from the signal control circuit 100.

(Principle and Operation of Electron Emission)

The principle of the electron emission of the electron emitting apparatus 10 having the above-described structure will now be explained. Hereinafter, for the purpose of a brief description, the drive voltage Vin has a simple rectangular waveform different from the drive voltage Vin according to the first embodiment.

First, the state is described with reference to FIG. 6 in which the actual potential difference Vka (element voltage Vka) between the lower electrode 12 and the upper electrode 14 with reference to the lower electrode 12 is maintained at a predetermined positive voltage Vp and in which all the electrons in the emitter section 13 have been emitted without remaining in the emitter section 13. At this stage, the negative pole of the dipole in the emitter section 13 is oriented toward the upper surface of the emitter section 13, (i.e., oriented in the positive direction of the Z axis toward the upper electrode 14). This state is observed at a point p1 on the graph shown in FIG. 7. The graph in FIG. 7 shows the voltage-polarization characteristic of the emitter section 13 and has the abscissa indicating the element voltage Vka and the ordinate indicating the charge Q accumulated in the element 10.

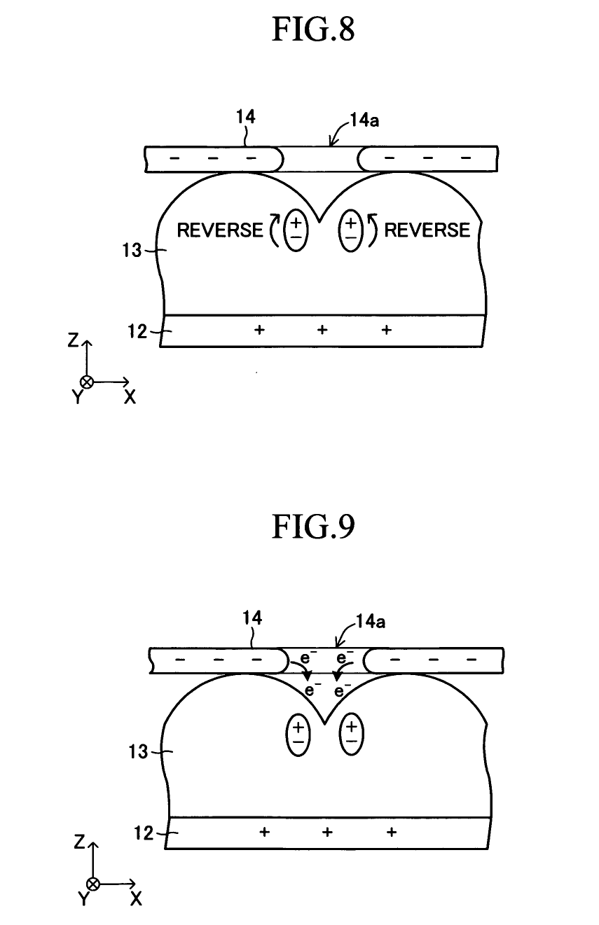

At this state, when the drive voltage Vin is set to a predetermined negative voltage Vm2 so that the element voltage Vka becomes the predetermined negative voltage Vm2, the element voltage Vka decreases toward a point p3 via a point p2 in FIG. 7. Once the element voltage Vka is decreased to near the negative coercive field voltage Va shown in FIG. 7, the orientation of the dipoles in the emitter section 13 starts reversing. In other words, the polarization reversal (negative-side polarization reversal) starts, as shown in FIG. 8. The polarization reversal increases the electric field in the contact sites (triple junctions) between the upper surface of the emitter section 13, the upper electrodes 14, and the ambient medium (in this embodiment, vacuum) and/or the electric field at the distal end portions of the upper electrodes 14 forming the micro through holes 14a. (In other words, electrical field concentration occurs at these sites). As a result, as shown in FIG. 9, the electrons are started to be supplied toward the emitter section 13 from the upper electrodes 14.

The supplied electrons are accumulated mainly in the upper part of the emitter section 13 near the region exposed through the micro through hole 14a and near the distal end portions of the upper electrode 14 that define the micro through hole 14a (this portion where the electrons are accumulated is hereinafter simply referred to as the region “near the micro through hole 14a of the emitter section 13”). Subsequently, when and after a predetermined time passes and the negative-side polarization reversal is completed, and the element voltage Vka rapidly changes toward the predetermined negative voltage Vm2. As a result, electron accumulation is completed, (i.e., a saturation state of electron accumulation is reached). This state is observed at a point p4 in FIG. 7.

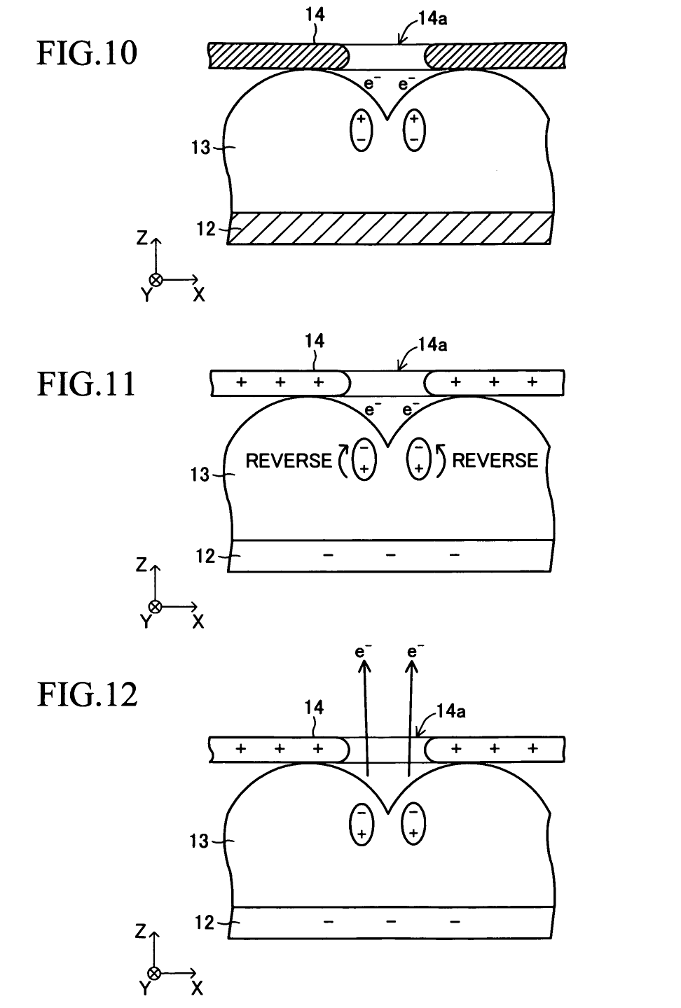

At this state, the drive voltage Vin is set to a predetermined positive voltage (second voltage) Vp2 so that the element voltage Vka becomes the predetermined positive voltage Vp2. Thus, the element voltage Vka starts to increase. Until the element voltage Vka becomes the voltage Vb (point p6) slightly smaller than the positive coercive field voltage Vd corresponding to a point p5 in FIG. 7, the charge state of the emitter section 13 is maintained, as shown in FIG. 10. Subsequently, the element voltage Vka reaches a value near the positive coercive field voltage Vd. This causes the negative poles of the dipoles to orient toward the upper surface of the emitter section 13. In other words, as shown in FIG. 11, the polarization reversal starts for the second time, (i.e., the positive-side polarization reversal is initiated). This state is observed near the point p5 in FIG. 7.

Subsequently, the positive-side polarization reversal advances, and thus, the number of the dipoles having negative poles oriented toward the upper surface of the emitter section 13 increases. As a result, as shown in FIG. 12, the electrons accumulated near the micro through holes 14a of the emitter section 13 are started to be emitted in the upward direction (the positive direction of the Z axis) through the micro through holes 14a by Coulomb repulsion.

Then, the positive-side polarization reversal completes. As a consequence, the element voltage Vka starts to increase rapidly, and the element voltage Vka reaches the positive predetermined voltage Vp2 (at the state p1 in FIG. 7). During this operation, electrons are emitted and then all electrons are emitted. Thereafter, the drive voltage Vin is set again to the predetermined negative voltage Vm2 so that the element voltage Vka is a predetermined negative voltage Vm2. Thus, the element voltage Vka reduces toward the point p3 via the point p2 shown in FIG. 7. This summarizes the principle of a series of operation including electron accumulation (light OFF state) and electron emission (light ON or emission state).

When a plurality of elements exist, the drive voltage applying circuit 21 sets the drive voltage Vin of only the upper electrodes 14 (between the upper and lower electrodes) from which electron emission is required at the predetermined negative voltage Vm2 to accumulate electrons, and maintains the drive voltage Vin of upper electrodes 14 from which no electron emission is required at “zero (0) V”. Subsequently, the drive voltage applying circuit 21 simultaneously sets the drive voltage Vin of all of the upper electrodes 14 at the predetermined positive value Vp2. According to this drive voltage Vin, electrons are emitted from the upper electrodes 14 (micro through holes 14a) of only the elements in which electrons have been accumulated in the emitter section 13. Thus, no polarization reversal occurs in the portions of emitter section 13 near the upper electrodes 14 from which no electron emission is required.

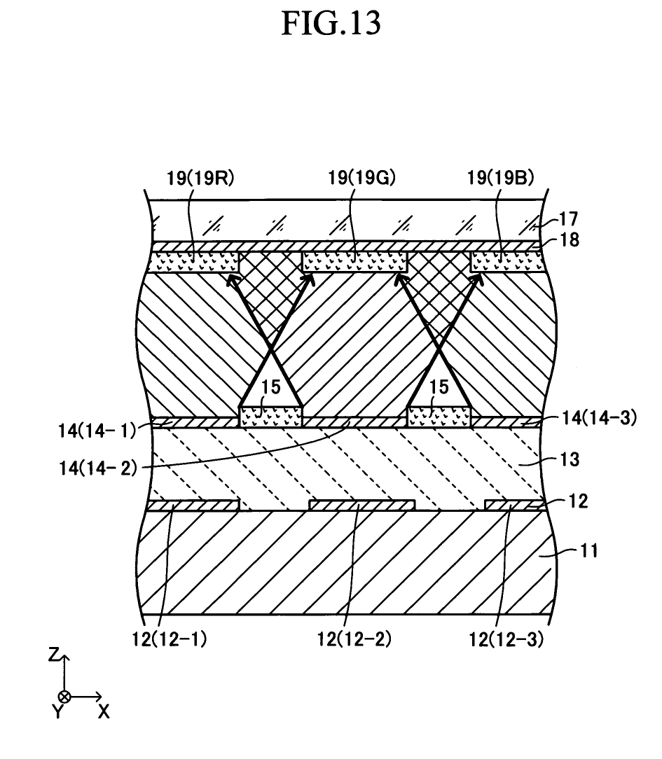

When electrons are emitted through the micro through holes 14a of the upper electrodes 14, the electrons travel in the positive direction of the Z axis by spreading (into the shape of a cone), as shown in FIG. 13. Thus, in an apparatus of the related art, electrons emitted from one upper electrode 14, e.g., the second upper electrode 14-2, reach not only the phosphor 19, e.g., the green phosphor 19G, directly above that upper electrode 14 but also the phosphors 19, e.g., the red phosphor 19R and the blue phosphor 19B, adjacent to this phosphor 19. This decreases color purity and sharpness of images.

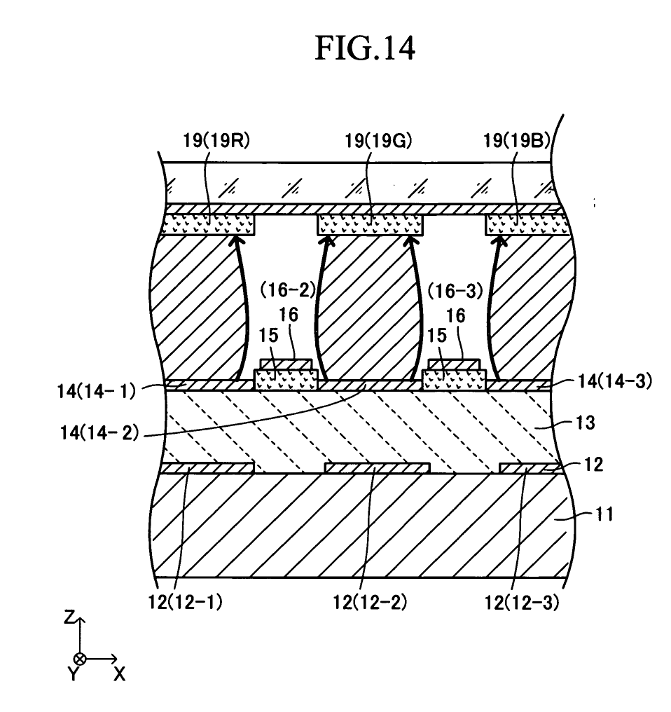

In contrast, the electron emitting apparatus 10 of this embodiment has focusing electrodes 16 to which a negative potential is applied. Each focusing electrode 16 is interposed between the adjacent upper electrodes 14 (i.e., between the upper electrodes of the adjacent elements) and is disposed at a position slightly above the upper electrodes 14. Thus, as shown in FIG. 14, the electrons emitted from the micro through holes 14a travel substantially directly upward without spreading owing to the electric field generated by the focusing electrode 16.

As a result, the electrons emitted from the first upper electrode 14-1 reach only the red phosphor 19R, the electrons emitted from the second upper electrode 14-2 reach only the green phosphor 19G, and the electrons emitted from the third upper electrode 14-3 reach only the blue phosphor 19B. Thus, the color purity of the display does not decrease, and sharper images can be obtained.

(Control of Drive Voltage Vin)

Next, a description is given of the control of the drive voltage Vin by the drive voltage applying circuit 21. In the specification, an expression that the drive voltage Vin is a positive voltage means that the drive voltage Vin is a voltage which sets, at the positive voltage, the potential (element voltage Vka) of the upper electrode 14 relative to the potential (element voltage Vka) of the lower electrode 12″. Therefore, an expression that the drive voltage Vin is a negative voltage means that the drive voltage Vin is a voltage which sets the element voltage Vka at the negative voltage”.

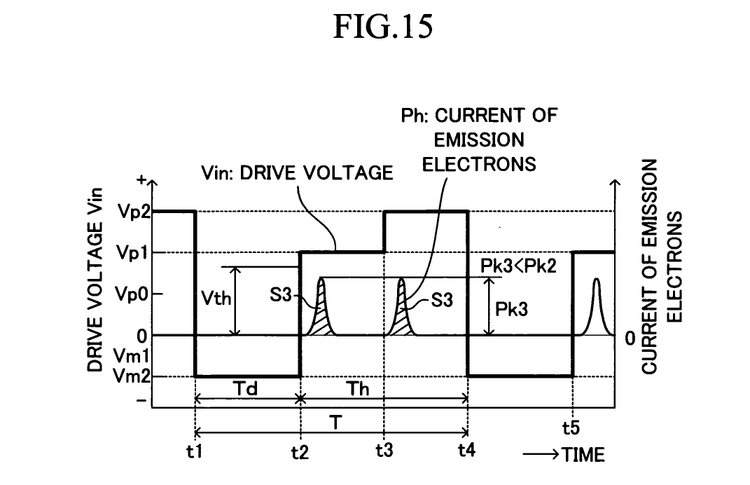

First, the power supply 21s of the drive voltage applying circuit 21 sets the drive voltage Vin at a predetermined negative voltage Vm2 (e.g., −70V) at a time t1, a predetermined timing, as shown in FIG. 15. Thus, the element voltage Vka alters toward the predetermined negative voltage Vm2. Therefore, the negative-side polarization reversal is caused in the emitter section 13, and electrons are supplied to the emitter section 13 from the upper electrode 14 and are accumulated in the region near the micro through hole 14a of the emitter section 13.

When the charge accumulation period Td passes from the time t1, i.e., at the time t2, the power supply 21s of the drive voltage applying circuit 21 sets the drive voltage Vin at a predetermined positive voltage Vp1 (e.g., +200V). As a consequence, the element voltage Vka alters toward the predetermined positive voltage Vp1. The predetermined positive voltage Vp1 is higher than the above-mentioned positive coercive field voltage Vd, and is not less than the minimum voltage (electron emission threshold voltage Vth) for starting the electron emission when the element 10 is in the state where it holds (accumulates) the electrons. Thus, the positive-side polarization reversal starts and the electrons accumulated in the region near the micro through holes 14a are emitted via the micro through holes 14a. The predetermined positive voltage Vp1 is also referred to as the “first voltage” for the convenience sake.

When a predetermined time passes from the time t2, the first electron-emission ends. After that, at a time t3, the power supply 21s of the drive voltage applying circuit 21 sets the drive voltage Vin at the predetermined positive voltage Vp2 (e.g., +300V). The predetermined positive voltage Vp2 is higher than the predetermined positive voltage Vp1. Therefore, the element voltage Vka alters toward the voltage Vp2 which is higher than the above-mentioned electron emission threshold voltage Vth and which is higher than the first voltage Vp1. The predetermined positive voltage Vp2 is also referred to as a “second voltage” for the convenience sake.

As a consequence, during the period (first electron-emission period) from the time t2 to the time t3, the dipoles having the negative poles that have not reversed to orient toward the upper surface of the emitter section 13 (i.e. have not undergone the positive-side polarization reversal) start the positive-side polarization reversal after the time t3. Therefore, Coulomb repulsion is generated again and thereby the electrons remaining in the region near the micro through holes 14a of the emitter section 13 are emitted in the upward direction via the micron through holes 14a. In other words, just after the time t3, second electron-emission is performed. The period of the time t3 to t4 may be referred to as a second electro-emission period.

When a predetermined time passes, at the time t4 (i.e., when the electron-emission period Th passes from the time t2), the power supply 21d of the drive voltage applying circuit 21 sets the drive voltage Vin at the predetermined negative voltage Vm2 again. As a consequence, the accumulation of electrons to the emitter section 13 restarts. The drive voltage applying circuit 21 (power supply 21s) thereafter repeats the operation during the time t1 to t4.

(Control of Collector Electrode)

Next, a description is given of the control of a collector electrode by the collector voltage applying circuit 23. Within the collector voltage applying period starting from “time t2 at which the drive voltage Vin is set at the first voltage Vp1, serving as the predetermined positive voltage” to the “time just before the time t4 at which the drive voltage Vin is set at the predetermined negative voltage Vm2 to start the electron-accumulation to the emitter section 13 after the second electro-emission completes”, the collector voltage applying circuit 23 applies a voltage Vc to the collector electrode 18. In other words, the collector voltage applying circuit 23 connects the fixed connection point of the switching element 23b to the anode of the constant voltage source 23c for the collector voltage applying period.

By this operation, the collector electrode 18 generates the electric field for collecting the emitted electrons. As a result, the emitted electrons via the fine through holes 14a from the emitter section 13 are accelerated (i.e., given high energy) by the electric field generated by the collector electrode 18 and travel in the upward direction from the upper electrode 14. Thus, the phosphors 19 are irradiated with electrons having high energy, and therefore, high luminance is achieved.

Further, the collector voltage applying circuit 23 applies a voltage (e.g., 0V) lower than the voltage Vc to the collector electrode 18 during the period (collector voltage non-applying period) except for the collector voltage applying period. That is, the collector voltage applying circuit 23 connects the fixed connection point of the switching element 23b to the earthed switching point during the collector voltage non-applying period. The collector voltage non-applying period matches the charge accumulation period Td.

Thus, the collector electrode 18 does not generate the electric field for attracting (collecting) the emitted electrodes or reduces the intensity of such electric field. Thus, even if unnecessary electrons are emitted due to a large inrush current flowing through the element 10 during the charge accumulation period Td or due to an excessive large change rate in the element voltage (excessively large rate of voltage change) after the negative-side polarization reversal, the number of electrons reaching the phosphors 19 among the thus emitted electrons reduces. As a result, unnecessary light emission can be avoided.

The switching element 23b may be configured such that the earthed switching point is replaced by a floating point coupled to nowhere. In this case, the collector electrode 18 is caused to enter a floating state during the collector voltage non-applying period. The floating state of the collector electrode 18 prevents the generation of electro field for collecting the emitted electrons. Thus, by the reason similar to the above-mentioned reason, unnecessary electron emission can be avoided.

(Examples of Drive Voltage Applying Circuit, Focusing Electrode Potential Applying Circuit, and Collector Voltage applying Circuit)

The examples and operation of the drive voltage applying circuit 21, the focusing electrode potential applying circuit 22, and the collector voltage applying circuit 23 will now be explained.

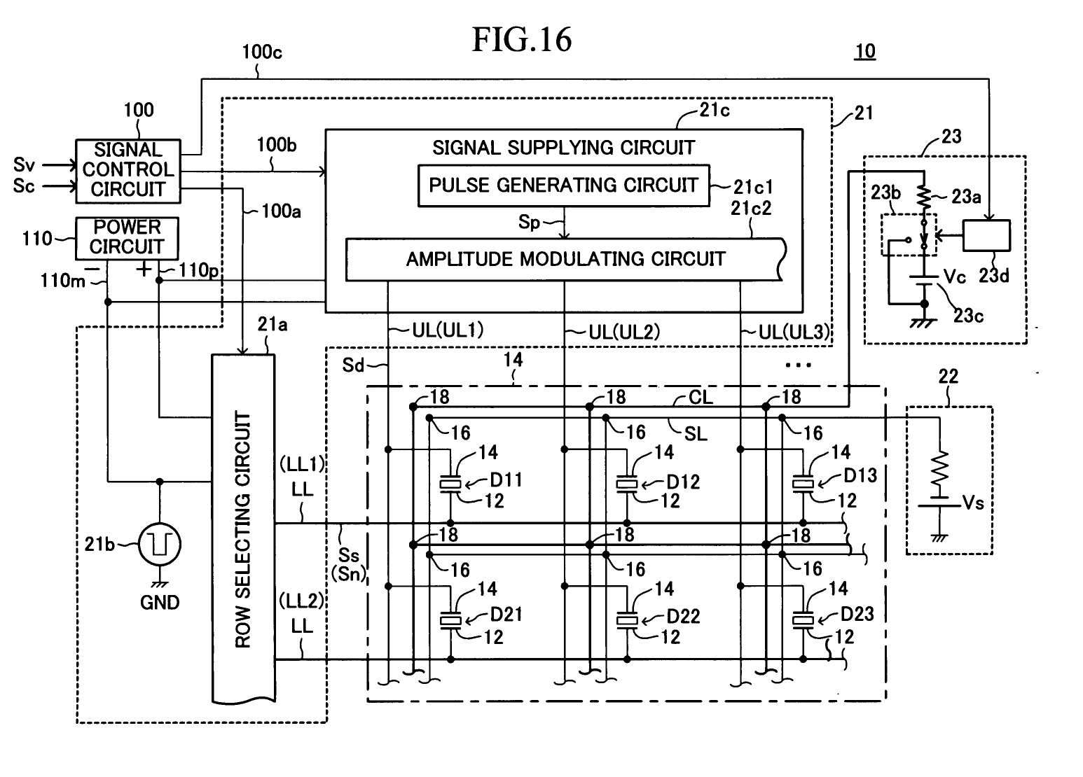

As shown in FIG. 16, the drive voltage applying circuit 21 comprises: a row selection circuit 21a; a pulse generator 21b; and a signal supplying circuit 21c. In FIG. 16, the components labeled D11, D12, . . . D22, and D23 each represent one element (one electron-emitting element constituted from the portion where upper electrode 14 is superimposed on the lower electrode 12 with the emitter section 13 therebetween). In this embodiment, the electron emitting apparatus 10 has a number n of elements in the row direction and a number m of elements in the column direction.

The row selection circuit 21a is connected to a control signal line 100a of the signal control circuit 100 and a positive electrode line 11 Op and a negative electrode line 110m of the power circuit 110. The row selection circuit 21a is also connected to a plurality of row selection lines LL. Each row selection line LL is connected to the lower electrodes 12 of a series of elements in the same row. For example, a row selection line LL1 is connected to the lower electrodes 12 of elements D11, D12, D13, . . . and D1m in the first row, and a row selection line LL2 is connected to the lower electrodes 12 of elements D21, D22, D23, . . . and D2m in the second row.

During the charge accumulation period Td in which electrons are accumulated in the emitter section 13 of each element, the row selection circuit 21a outputs a selection signal Ss (a 70V voltage signal in this embodiment) to one of the row selection lines LL for a predetermined period (row selection period) Ts and outputs non-selection signals Sn (a 0V voltage signal in this embodiment) to the rest of the row selection lines LL in response to the control signal from the signal control circuit 100. The row selection line LL to which the selection signal Ss is output from the row selection circuit 21a is sequentially changed every period Ts.

The pulse generator 21b generates a reference voltage (0V in this embodiment) during a charge accumulation period Td, further generates a first fixed voltage (−250V in this embodiment) during a first electron-emission period (corresponding to the period from the time t2 to t3 in FIG. 15) which is a former half period of the light emission period (light ON period or electron emitting period) Th, and furthermore generates a second fixed voltage (−350V in this embodiment) during the second electron-emission period (corresponding to the period from the time t3 to t4 in FIG. 15), which is a latter half period of the light emission period Th. The pulse generator 21b is coupled between the negative electrode line 110m of the power circuit 110 and the ground (GND).

The signal supplying circuit 21c is connected to the a control signal line 100b of the signal control circuit 100 and the positive electrode line 110p and the negative electrode line 110m of the power circuit 110. The signal supplying circuit 21c has a pulse generating circuit 21c1 and an amplitude modulator circuit 21c2 inside.

The pulse generating circuit 21c1 outputs a pulse signal Sp having a predetermined amplitude (70V in this embodiment) at a predetermined pulse period during the charge accumulation period Td, and outputs a reference voltage (0V in this embodiment) during the emission period Th.

The amplitude modulator circuit 21c2 is connected to the pulse generating circuit 21c1 so as to receive the pulse signal Sp from the pulse generating circuit 21c1. Further, the amplitude modulator circuit 21c2 is connected to a plurality of pixel signal lines UL. Each pixel signal line UL is connected the upper electrodes 14 of a series of elements in the same column. For example, a pixel signal line UL1 is connected to the upper electrodes 14 of the elements D11, D21, . . . and Dn1 of the first column, a pixel signal line UL2 is connected to the upper electrodes 14 of the elements D12, D22, . . . and Dn2 of the second column, and a pixel signal line UL3 is connected to the upper electrodes 14 of the elements D13, D23, ... and Dn3 of the third column.

During the charge accumulation period Td, the amplitude modulator circuit 21c2 modulates the amplitude of the pulse signal Sp according to the luminance levels of the pixels in the selected row, and outputs the modulated signal (a voltage signal of 0V, 35V, or 70V in this embodiment), which serves as a pixel signal Sd, to the pixel signal lines UL (UL1, UL2, . . . and ULm). During the emission period Th, the amplitude modulator circuit 21c2 outputs, without any modulation, the reference voltage (0V) generated by the pulse generating circuit 21c1.

The signal control circuit 100 receives a video signal Sv and a sync signal Sc and outputs a signal for controlling the row selection circuit 21a to the signal line 100a, a signal for controlling the signal supplying circuit 21c to the signal line 100b, and a signal for controlling the collector voltage applying circuit 23 to a signal line 100c based on these received signals.

The power circuit 110 outputs voltage signals to the positive electrode line 110p and the negative electrode line 110m so that the potential of the positive electrode line 110p is higher than the potential of the negative electrode line 110m by a predetermined voltage (50V in this embodiment).

The focusing electrode potential applying circuit 22 is coupled to a connecting line SL that connects all of the focusing electrodes 16. The focusing electrode potential applying circuit 22 applies to the connecting line SL a potential Vs with respect to the ground.

The collector voltage applying circuit 23 is connected to an interconnection line CL coupled to the collector electrode 18 and the signal line 100c of the signal control circuit 100. The collector voltage applying circuit 23 alternately applies the positive first voltage Vc (=first collector voltage V1) and the second voltage (second collector voltage V2 which is equal to the ground voltage, 0V, in this embodiment) smaller than the first voltage Vc to the interconnection line CL based on the signal received from the signal control circuit 100.

The operation of the circuit having the above-described structure will now be described. At the beginning of the charge accumulation period Td starting at a particular time, the row selection circuit 21a outputs a selection signal Ss (70V) to the row selection line LL1 of the first row based on the control signal from the signal control circuit 100 and outputs non-selection signals Sn (0V) to the rest of the row selection lines LL.

As a result, the potential of the lower electrodes 12 of the elements D11, D12, D13, . . . and D1m in the first row becomes the voltage (70V) of the selection signal Ss. The potential of the lower electrodes 12 of the other elements (for example, the elements D21, D22, . . . and D2m in the second row and the elements D31, D32, . . . and D3m in the third row) becomes the voltage (0V) of the non-selection signal Sn.

At this time, the signal supplying circuit 21c outputs pixel signals Sd (0V, 35V, or 70V in this embodiment) to the pixel signal lines UL (UL1, UL2, . . . and ULm) based on the control signal from the signal control circuit 100, the pixel signals Sd corresponding to the luminance level of the respective pixels constituted from the elements of the selected row, i.e., in this case, the elements D11, D12, D13, . . . and D1m in the first row. The potential difference between the pixel signal Sd and the selection signal Ss becomes the drive signal Vin.

For example, assuming that a 0V pixel signal Sd is supplied to the pixel signal line UL1, the element voltage Vka (D11) which is the potential difference between the upper electrode 14 and the lower electrode 12 of the element D11 is finally the aforementioned negative predetermined voltage Vm, i.e., −70V (=0V−70V, a first predetermined negative voltage). A large number of electrons are thus accumulated in the emitter section 13 in the region near the micro through holes 14a of the element D11. Assuming that a 35V pixel signal Sd is supplied to the pixel signal line UL2, the element voltage Vka (D12) is the aforementioned negative predetermined voltage Vm, i.e., −35V (=35V−70V, a second predetermined negative voltage). As a result, fewer electrons are accumulated in the region near the micro through holes 14a of the emitter section 13 in the element D12 than in the element D11.

Further, assuming that a 70V pixel signal Sd is supplied to the pixel signal line UL3, the element voltage Vka(D13) of the element D13 is 0V (=70V−70V). Thus, no polarization reversal occurs in the emitter section 13 of the element D13. That is, no electron is accumulated in the emitter section 13 of the element D13.

Once the row selection period Ts (which is long enough to accumulate electrons to the selected element) has elapsed, the row selection circuit 21a outputs a selection signal Ss (70V) to the row selection line LL2 of the second row based on the control signal from the signal control circuit 100 and outputs non-selection signals Sn (0V) to the rest of the row selection lines. By this operation, the potential of the lower electrodes 12 of the elements D21, D22, D23, . . . and D2m in the second row becomes the voltage (70V) of the selection signal Ss. The potential of the lower electrodes 12 of the rest of the elements (e.g., the elements D11 to D1m in the first row and the elements D31 to D3m in the third row) becomes the voltage (0V) of the non-selection signals Sn.

At this time, the signal supplying circuit 21c outputs pixel signals Sd (voltage signal of any of 0V, 35V, and 70V in this embodiment) to the plurality of pixel signal lines UL (UL1, UL2, and ULm) based on the control signal from the signal control circuit 100, the pixel signals Sd corresponding to the luminance level of the respective pixels constituted from the elements of the selected row, i.e., in this case, the elements D21, D22, D23, . . . and D2m in the second row. As a result, electrons are accumulated in the emitter sections of the elements D21, D22, D23, . . . and D2m in the second row, in amounts corresponding to the pixel signals Sd.

Note that the element voltage Vka of the element to which the 0V non-selection signal Sn is supplied is 0V (in this case, 0V potential of the upper electrode and 0V potential of the lower electrode), 35V (in this case, 35V potential of the upper electrode and 0V potential of the lower electrode), or 70V (in this case, 70V potential of the upper electrode and the 0V potential of the lower electro). However, these levels of voltage are not sufficient for polarization reversal in each of the elements in which the electrons have already been accumulated. That is, the element voltage Vka does not exceed the electron-emission threshold voltage Vth.

Further, when the row selection time Ts has elapsed, the row selection circuit 21a outputs the selection signal Ss (70V) to the row selection line LL3 (not shown) of the third row and outputs the non-selection signals Sn (0V) to the rest of the row selection lines. Meanwhile, the signal supplying circuit 21c outputs pixel signals Sd corresponding to the luminance levels of the respective pixels constituted from the elements in the selected third row to the plurality of pixel signal lines UL. Such an operation is repeated every row selection time Ts until all of the rows are selected. As a result, at a predetermined time point, electrons are accumulated in the emitter sections of all the elements in amounts (including “zero”) corresponding to the luminance levels of the respective elements. This summarizes the operation that takes place during the charge accumulation period Td.

In order to start the emission period Th (actually, first electron-emission period), the row selection circuit 21a applies a large negative voltage (in this embodiment, the applied voltage is −200V, i.e., the difference between +50V generated by the power circuit 110 and −250V generated by the pulse generator 21b) to all of the row selection lines LL. Meanwhile, the signal supplying circuit 21c outputs the reference voltage (0V), which is generated by the pulse generating circuit 21c1, through the amplitude modulator circuit 21c2 without modulation to all of the pixel signal lines UL. As a result, the potential of the upper electrodes 14 of all the elements becomes the reference voltage (0V).

Thus, the drive voltage Vin applied to all the elements is set at the first voltage Vp1 (=200V). Therefore, the positive-side polarization reversal is caused in each of the emitter sections 13 of the elements and the electrons accumulated in each of the emitter sections 13 of the elements are partly emitted concurrently by Coulomb repulsion. This causes the phosphors disposed above the elements to emit light and to thereby display images. Note that in the emitter section of the elements, to which a zero voltage Vin between the upper and the lower electrodes was applied during the charge accumulation period Td and therefore, which have not accumulated electrons, no negative-side polarization reversal has occurred. Thus, no positive-side polarization reversal occurs even when the voltage Vin between the upper and lower electrodes is set at the large positive voltage. Accordingly, for example, the element that is not required to emit light for the purpose of producing a particular image at a particular timing does not consume excess energy that accompanies the polarization reversal.

After the first electron-emission period, the row selection circuit 21a applies a large negative voltage (in this embodiment, −300V, which is a difference between +50V generated by the power circuit 110 and −350V generated by the pulse generator 21b) to all the row selection lines LL. The signal supplying circuit 21c outputs the reference voltage (0V) generated by the pulse generating circuit 21c1 via the amplitude modulator circuit 21c2 without modulation to all the pixel signal lines UL. As a consequence, the potential of the upper electrodes 14 of all the elements becomes the reference voltage (0V).

Thus, the drive voltage Vin applied to all the elements is set at the second voltage Vp2 (=300V). Therefore, the dipoles, that have not undergone (completed) the positive-side polarization reversals during the first electron-emission period, undergo the positive-side polarization reversals. Thus, the rest of electrons in the emitter section 13 are emitted concurrently by Coulomb repulsion. This causes the phosphors disposed above the elements to emit light and to thereby display images.

As is described above, during the charge accumulation period Td, the drive voltage applying circuit 21 consecutively (sequentially) sets the drive voltage Vin for the plurality of elements at the predetermined negative voltage one after next. Upon completion of electron accumulation in all the elements, the drive voltage applying circuit 21 simultaneously sets the drive voltage Vin for all the elements at the first voltage Vp1, which is the predetermined positive voltage to cause concurrent electron emission from all of the elements, and subsequently, at the second voltage Vp2, which is the predetermined positive voltage to cause concurrent electron emission from all of the elements. After the predetermined emission period Th has elapsed, the drive voltage applying circuit 21 again starts the charge accumulation period Td.

As is previously stated, the electron emitting apparatus 10 according to the first embodiment of the present invention comprises the drive voltage applying circuit 21 which applies between the lower electrode 12 and the upper electrode 14 the drive voltage Vin to cause the element voltage Vka, which is the potential of the upper electrode 14 with respect to the potential of the lower electrode 12, to be the negative voltage Vm2 (Vm) and thereafter to be the positive voltage. Further, the drive voltage applying circuit 21 is configured as to stepwise increases the positive voltage (to the first voltage Vp1 during the first electron-emission period and to the second voltage Vp2 larger than the first voltage Vp1 during the second electron-emission period).

Thus, upon setting the element voltage Vka at the negative voltage, the electrons are accumulated to the emitter section. Then, the accumulated electrons are emitted every stepwise increase in the element voltage Vka.

In other words, the electrons accumulated in the emitter section 13 per one electron-accumulation (during the each electron-accumulation period Td) are emitted at a plurality of times via the micro through holes 14a of the upper electrode 14. Thus, even if the absolute value of the negative voltage applied to the element voltage Vka during the electron accumulation period Td is large and a large number of electrons are accumulated in the emitter section, the amount of electrons emitted by each one operation of the electron-emission is smaller than that of the conventional case. As a result, since inrush current does not flow through the electron emitting apparatus 10, the deterioration of the element due to the heating is avoided and the total amount of emitted electrons during the predetermined period T increases. Further, the dipoles in the emitter section 13 rotate only once (reverses twice) during the period from one electron accumulation operation to completion of emitting electrons accumulated in the one electron accumulation. Therefore, since the number of polarization reversal does not increase, the deterioration of the elements is suppressed.

In addition, in general, if and when an excessively large amount of electrons collide with the phosphor 19, the energy of the electrons changes to the heat and thus the amount of emission light from the phosphor is not increased. After ending the collision of electrons, the phosphor 19 still emits light (remaining light) whose amount decreases in accordance with the time elapse. When a proper amount of electrons with which the energy of electrons does not change to the heat are collided and thereafter the collision of electrons stops. Therefore, the phosphor 19 can emit light with high efficiency, if electrons whose amount is proper in that energy of the electrons does not change to the heat are caused to collide with the phosphor 19, then, the collision of electrons is stopped, and then electrons are caused to collide with the phosphor 19 again at the proper timing when an amount of light (remaining light) becomes small.

Thus, as the electron-emitting apparatus according to the first embodiment, a large amount of emission light is generated with small power-consumption by repeating the electron emission for a short period a plurality of times and causing the emitted electrons to collide with the phosphor, while suppressing an amount of emitted electrons for each of the electron emissions, since energy of the electrons does not change to the heat and the remaining light of the phosphor can be utilized. As a result, it is possible to provide a display device showing a clear image or a light-emitting device capable of emitting a large amount of light.

Further, in the first embodiment, the predetermined potential (Vs) is applied to the focusing electrodes. Therefore, the electrons emitted from each of the upper electrodes 14 of the elements are irradiated only to the phosphor existing on the direct upper portion of the upper electrode 14. As a consequence, clear image is provided.

The collector voltage applying circuit 23 applies the voltage Vc to the collector electrode 18 during the collector voltage applying period, and further applies the voltage (e.g., 0V) smaller than the voltage Vc to the collector electrode 18 during the collector voltage non-applying period. Thus, during the electron emission period Th, the electric field generated by the collector electrode allows the electrons emitted via the micro through holes 14a of the upper electrode 14 from the emitter section 13 to collide with the phosphor 19 certainly. Further, the electric field generated by the collector electrode accelerates the electrons by applying the energy to the emitted electrons, thereby increasing the amount of emission light of the phosphor 19. In addition, only the electrons emitted during the electron emission period Th are certainly led toward the phosphor 19 and it can be avoided that the electrons emitted during the electron accumulation period Td reach the phosphor 19.

### Second Embodiment

An electron-emitting apparatus according to a second embodiment of the present invention will now be described. The electron-emitting apparatus according to the second embodiment is different from the electron-emitting apparatus 10 according to the first embodiment only in that the apparatus according to the second embodiment alters the drive voltage Vin differently from the drive voltage Vin in the electron-emitting apparatus 10 according to the first embodiment. Therefore, the different point is mainly described hereinafter.

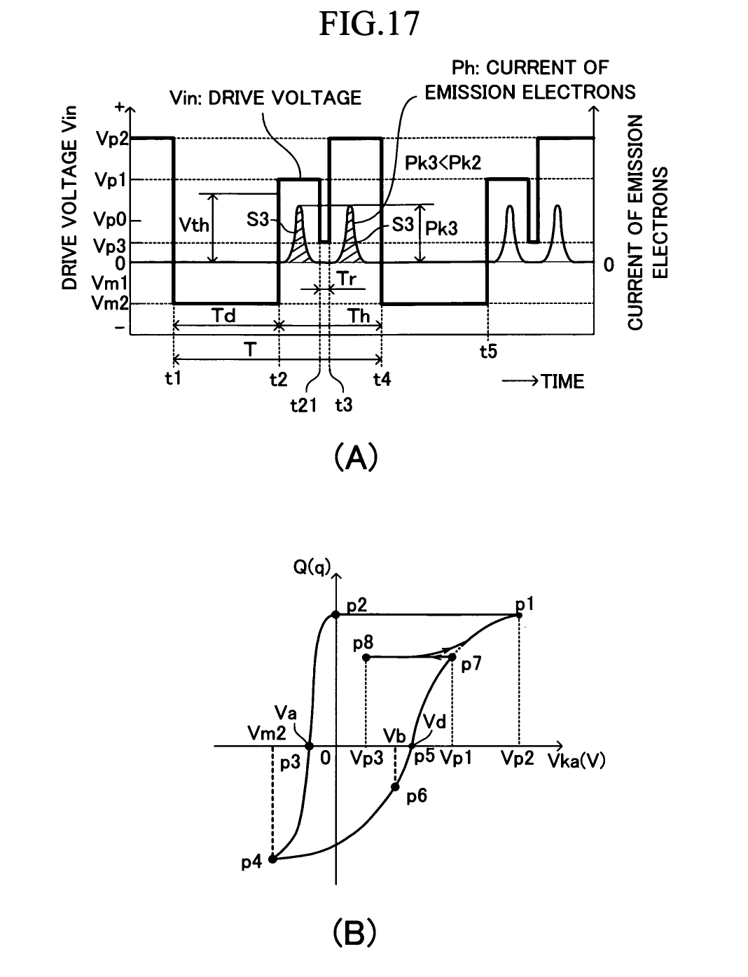

Similarly to the drive voltage applying circuit 21 according to the first embodiment, as shown in FIG. 17(A), the drive voltage applying circuit 21 according to the second embodiment applies, between the lower electrode 12 and the upper electrode 14 (to interelectrodes), the drive voltage Vin for setting the element voltage Vka to the negative voltage Vm2 during the electron accumulation period Td starting from the time t1. Thus, the electrons are accumulated in the region of the emitter section 13 near the micro through holes 14a.

Further, at the time t2 when the electron accumulation period Td passes, the drive voltage applying circuit 21 according to the second embodiment applies to interelectrodes the drive voltage Vin (i.e., first predetermined voltage Vp1) which sets the element voltage Vka to the predetermined positive voltage (first voltage) Vp1. Thus, the positive-side polarization reversal is caused, the first electron-emission occurs.

At a time t21 at which the first electron-emission is completed when a predetermined time (first electron-emission period) elapses from the time t2 and the time reaches, the drive voltage applying circuit 21 applies the drive voltage Vin (i.e., third voltage Vp3) to the interelectrodes to cause the element voltage Vka to become the third voltage Vp3. The third voltage Vp3 is a voltage which is smaller than the first voltage Vp1 and which does not cause the element to accumulate electrons in the emitter section 13.

Just before the end of the first electron-emission period (time t21), a large part of dipoles designed to undergo the positive-side polarization reversal by setting the element voltage Vka at the first voltage Vp1 actually have completed the positive-side polarization reversal. However, a part of such dipoles have not undergone the positive-side polarization reversal or are just undergoing the reversal.

Therefore, if the element voltage Vka is promptly changed to a voltage larger than the first voltage Vp1 at the time t21 or at the time t3 just after the time t21, next electron-emission (second electron-emission) may start without the interrupt (halt) of electron emission. Such continuous electron-emission is not preferable for a device (e.g., a display device) which requires the electron emission at a predetermined timing only.

On the contrary, the drive voltage applying circuit 21 according to the second embodiment temporarily stops the polarization reversal to completely stop the electron emission by temporarily keeping the element voltage Vka to the third voltage Vp3 without increasing immediately the element voltage Vka just after the first electron-emission period. That is, as shown in a graph of the characteristics between the voltage and the polarization of the emitter section 13 in FIG. 17(B), the drive voltage applying circuit 21 changes the element state from a point p7 to a point p8. As will be understood with reference to the graph, there is no difference between the amount of charges (amount of electrons) kept by the emitter section 13 at the point p7 and the amount of charges (amount of electrons) kept by the emitter section 13 at the point p8. In other words, even if the element state changes from the point p7 to the point p8, the electrons are kept in the emitter section 13 without change and are not emitted.

Thereafter, at the time t3 when a short time elapses from the time t21, the drive voltage applying circuit 21 then applies to the interelectrodes the drive voltage Vin (i.e., second voltage Vp2) for setting the element voltage Vka at the second voltage Vp2 larger than the first voltage Vp1. As a result, the dipoles that have not completed the positive-side polarization reversal start the positive-side polarization, and thus, the electrons remaining in a region of the emitter section 13 near the micro through holes 14a. In other words, the second electron-emission is performed.

As mentioned above, in the electron-emitting apparatus according to the second embodiment, the drive voltage applying circuit 21 is configured to temporarily set the element voltage Vka at the voltage (the third voltage) Vp3 which is smaller than the first voltage Vp1 and which does not cause the element 10 to accumulate the electrons in the emitter section 13, upon increasing the potential (the element voltage Vka) of the upper electrode 14 with respect to the potential of the lower electrode 12 from the first voltage Vp1 as the positive voltage to the second voltage Vp2 larger than the first voltage Vp1 for the purpose of electron emission.

By the configuration above, it becomes possible to certainly provide a period for preventing (stopping) the electron-emission between two successive (continuous) electron-emission periods. As a consequence, the electrons can be emitted at the timing corresponding to the request of a display to which the electron-emitting apparatus 10 is applied. That is, the frequency for electron emission substantially increases.

### Third Embodiment

Next, an electron-emitting apparatus according to the third embodiment of the present invention will be described. The electron-emitting apparatus according to the third embodiment is different from the electron-emitting apparatus 10 according to the first embodiment only in that the apparatus according to the third embodiment alters the drive voltage Vin differently from the drive voltage Vin in the electron-emitting apparatus 10 according to the first embodiment. Therefore, the different point is mainly described hereinafter.

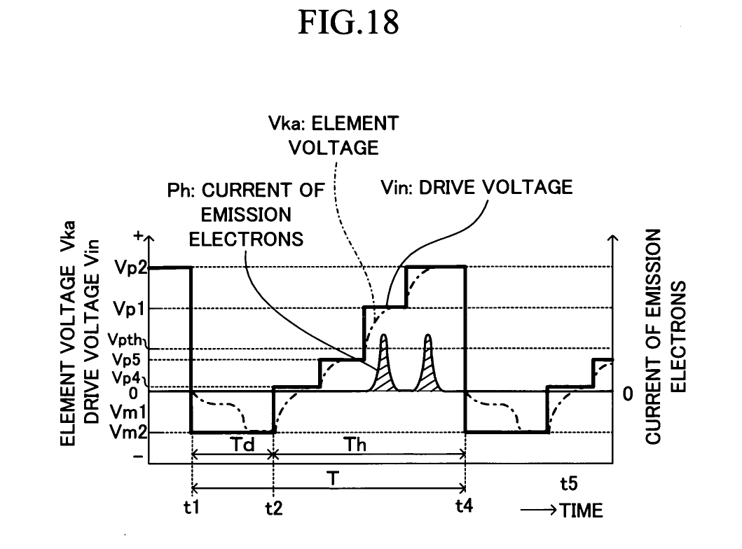

Referring to FIG. 18, similarly to the drive voltage applying circuit 21 according to the first embodiment, the drive voltage applying circuit 21 according to the third embodiment applies between the lower electrode 12 and the upper electrode 14 (to the interelectrodes) the drive voltage Vin for setting the element voltage Vka to the negative voltage Vm2 during the electron accumulation period Td starting from the time t1. Thus, the electrons are accumulated in the region of the emitter section 13 near the micro through holes 14a.

Further, at the time t2 when the electron accumulation period Td elapses,the drive voltage applying circuit 21 according to the third embodiment increases the drive voltage Vin (i.e., element voltage Vka) gradually and stepwise every predetermined time. Specifically, at the time t2 when the electron accumulation period Td elapses, the drive voltage applying circuit 21 keeps the drive voltage Vin to a fourth voltage Vp4 which is the positive voltage for a predetermined period, and subsequently keeps the drive voltage Vin to a fifth voltage Vp5 (Vp1>Vp5>Vp4) which is the positive voltage for a predetermined period. In this case, the fourth voltage Vp4 and the fifth voltage Vp5 are selected to be values by which the positive-side polarization reversal is not caused, i.e., voltages smaller than the electron emission threshold voltage Vth. Therefore, when the element voltage Vka becomes the fourth voltage Vp4 and the fifth voltage Vp5, the electrons are not emitted. Thereafter, the drive voltage applying circuit 21 sets the drive voltage Vin at the first voltage Vp1 throughout the first period, and subsequently sets the drive voltage Vin at the second voltage Vp2 throughout the second period. Thus, the first electron-emission is performed for the first period and the second electron-emission is performed for the second period.

As mentioned above, the electron-emitting apparatus according to the third embodiment applies the drive voltage Vin for stepwise increasing the element voltage Vka to the interelectrodes before the element voltage Vka reaches the voltage necessary for starting the electron emission after the electron accumulation.

Thus, similarly to the first and second embodiments, the electrons which are accumulated once are emitted separately at a plurality of times, and therefore the total amount of emitted electrons can be increased without reducing the lifetime of the element 10. Further, although the drive voltage Vin stepwise but gradually increases. Thus, the element voltage Vka follows the drive voltage Vin. Therefore, the polarization reversal and the electron emission are performed while the difference between the drive voltage Vin and the element voltage Vka is small. As a consequence, the power consumption (Joule heat) at the resistance of the element, the resistance near the element and the circuit resistance is reduced.

Thus, since the element is not heated, the change in characteristics of the emitter section due to the heat is avoided. Further, since the element temperature is not high, the generation of gas consisting of materials absorbed to the element is avoided. As a result, the generation of plasma is prevented and therefore the excessive emission of electrons (generation of large light-emission) and the element damage due to the ion bombardment are avoided.

### Fourth Embodiment

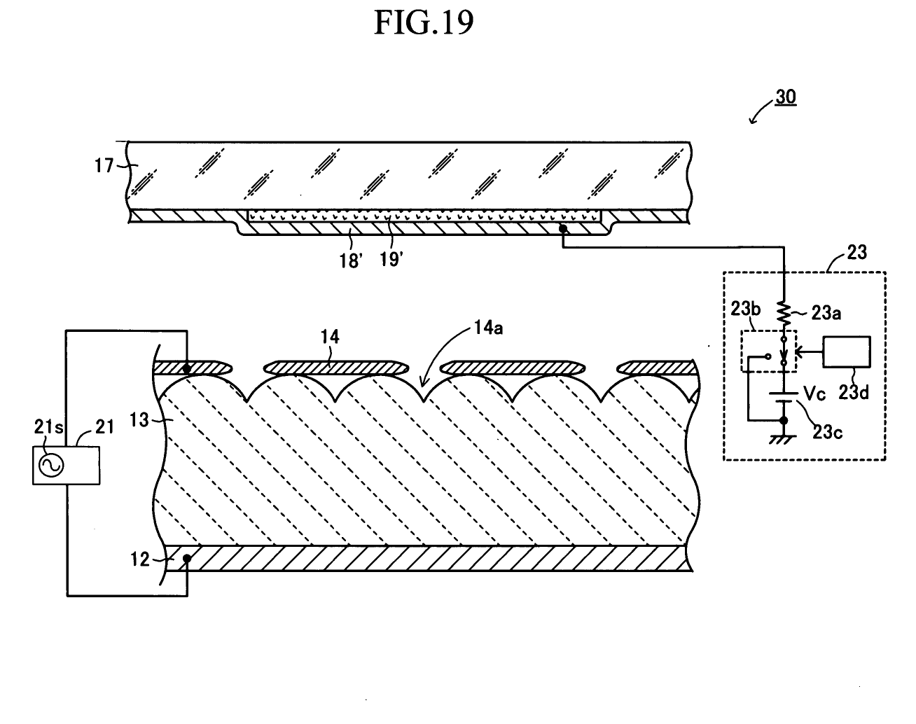

Next, a description is given of an electron-emitting apparatus 30 according to the fourth embodiment of the present invention with reference to FIG. 19. The electron-emitting apparatus 30 is different from the electron-emitting apparatus 10 in that the electron-emitting apparatus 10 includes a collector electrode 18′ and a phosphor 19′ in place of the collector electrode 18 and the phosphor 19 in the electron emitting apparatus 10, respectively. Thus, the description below is mainly directed to this difference.

In the electron-emitting apparatus 30, the phosphor 19′ is disposed on the back surface of the transparent plate 17 (i.e., on the surface facing the upper electrode 14), and the collector electrode 18′ is disposed to cover the phosphor 19′. The collector electrode 18′ has a thickness that allows electrons emitted from the emitter section 13 via the micro through holes 14a in the upper electrode 14 to travel through (penetrate) the collector electrode 18′. The thickness of the collector electrode 18′ is preferably 100 nm or less. The thickness of the collector electrode 18′ can be larger as the kinetic energy of the emitted electrons is higher.

The configuration of this embodiment is typically employed in cathode ray tubes (CRTs). The collector electrode 18′ functions as a metal back. The electrons emitted from the emitter section 13 through the micro through holes 14a in the upper electrode 14 travel through the collector electrode 18′, enter the phosphor 19′, and excite the phosphor 19′, thereby causing light emission. The advantages of the electron-emitting apparatus 30 are as follows:

(a) When the phosphor 19′ is not electrically conductive, electrification (negative charging) of the phosphor 19′ can be avoided. Thus, the electric field that accelerates electrons can be maintained.

(b) Since the collector electrode 18′ reflects light generated by the phosphor 19′, the light can be emitted toward the transparent plate 17-side (emission surface side) with higher efficiency.

(c) Since collision of excessive electrons against the phosphor 19′ can be avoided, deterioration of the phosphor 19′ and the generation of gas from the phosphor 19′ can be avoided.

(Materials of Constituent Components and Production Examples)

The materials of the constituent components of the electron-emitting apparatuses described above and the method for producing the constituent components will now be described.

(Lower Electrode 12)

The lower electrode is made of an electrically conductive material described above. Examples of the preferable materials for the lower electrode will be described in detail below:

(1) Conductors resistant to high-temperature oxidizing atmosphere (e.g., elemental metals or alloys)

Examples: high-melting-point noble metals such as platinum, iridium, palladium, rhodium, and molybdenum

Examples: materials mainly made of a silver-palladium alloy, a silver-platinum alloy, or a platinum-palladium alloy

(2) Mixtures of ceramics having electrical isolation and being resistant to high-temperature oxidizing atmosphere and elemental metals

Example: a cermet material of platinum and a ceramic

(3) Mixtures of ceramics having electrical isolation and being resistant to high-temperature oxidizing atmosphere and alloys

(4) Carbon-based or graphite-based materials

Among these materials above, elemental platinum and materials mainly composed of platinum alloys are particularly preferable. It should be noted that when a ceramic material is added to the electrode material, it is preferable to use roughly 5 to 30 percent by volume of the ceramic material. Materials similar to those of the upper electrode 14 described below may also be used for the lower electrode. The lower electrode is preferably formed by a thick-film forming process. The thickness of the lower electrode is preferably 20 μm or less and most preferably 5 μm or less.

(Emitter Section 13)

The dielectric material that constitutes the emitter section may be a dielectric material having a relatively high relative dielectric constant (for example, a relative dielectric constant of 1,000 or higher). Examples of the preferable material for the emitter section are as follows:

(1) Barium titanate, lead zirconate, lead magnesium niobate, lead nickelniobate, lead zinc niobate, lead manganese niobate, lead magnesium tantalate, lead nickel tantalate, lead antimony stannate, lead titanate, lead magnesium tungstate, and lead cobalt niobate

(2) Ceramics containing any combination of the substances listed in (1) above

(3) Ceramics described in (2) further containing an oxide of lanthanum, calcium, strontium, molybdenum, tungsten, barium, niobium, zinc, nickel, or manganese; ceramics described in (2) further containing any combination of the oxides described above; and ceramics described in (2) further containing other compounds

(4) Materials mainly containing 50% or more of the materials listed in (1) above

It is noted that, for example, a two-component system containing lead magnesium niobate (PMN) and lead titanate (PT), i.e., nPMN-mPT (n and m represent molar ratios), can exhibit a decreased Curie point and a large relative dielectric constant at room temperature by increasing the molar ratio of the PMN. In particular, nPMN-mPT having n of 0.85 to 1.0 and m of 1.0-n exhibits a relative dielectric constant of 3,000 or higher and is thus particularly preferable as the material for the emitter section. For example, the nPMN-mPT having n of 0.91 and m of 0.09 exhibits a relative dielectric constant of 15,000 at room temperature. The nPMN-mPT having n of 0.95 and m of 0.05 exhibits a relative dielectric constant of 20,000 at room temperature.

Furthermore, a three-component system containing lead magnesium niobate (PMN), lead titanate (PT), and lead zirconate (PZ), i.e., PMN-PT-PZ, can exhibit a higher relative dielectric constant by increasing the molar ratio of PMN. In this three-component system, the relative dielectric constant can be increased by adjusting the composition to near the morphotropic phase boundary (MPB) between the tetragonal and pseudo cubic phases or between the tetragonal and rhombohedral phases.

For example, PMN:PT:PZ of 0.375:0.375:0.25 yields a relative dielectric constant of 5,500, and PMN:PT:PZ of 0.5:0.375:0.125 yields a relative dielectric constant of 4,500. These compositions are particularly preferable as the material for the emitter section.

Furthermore, a metal, such as platinum, may be preferably added to the dielectric material as long as the insulating ability can be ensured in order to increase the dielectric constant. For example, 20 percent by weight of platinum may preferably be added to the dielectric material.

A piezoelectric/electrostrictive layer, a ferroelectric layer or an antiferroelectric layer may be used as the emitter section. When the emitter section is a piezoelectric/electrostrictive layer, the piezoelectric/electrostrictive layer may be composed of a ceramic containing lead zirconate, lead magnesium niobate, lead nickel niobate, lead zinc niobate, lead manganese niobate, lead magnesium tantalate, lead nickel tantalate, lead antimony stannate, lead titanate, barium titanate, lead magnesium tungstate, lead cobalt niobate, or any combination of these.

Obviously, the emitter section may be made of a material containing 50 percent by weight or more of the above-described compound as the main component. Among the ceramics described above, a ceramic containing lead zirconate is most frequently used as the constituent material for the piezoelectric/electrostrictive layer that serves as the emitter section.

When the piezoelectric/electrostrictive layer is formed using a ceramic, the ceramic may further contain an oxide of lanthanum, calcium, strontium, molybdenum, tungsten, barium, niobium, zinc, nickel, or manganese, or any combination of these oxides, or other compounds. The ceramic described above may further contain SiO₂, CeO₂, Pb₅Ge₃O₁₁, or any combination of these. In particular, a PT-PZ-PMN-based piezoelectric material containing 0.2 percent by weight of SiO₂, 0.1 percent by weight of CeO₂, or 1 to 2 percent by weight of Pb₅Ge₃O₁₁ is preferable.

In detail, for example, a ceramic mainly composed of lead magnesium niobate, lead zirconate, and lead titanate, and containing lanthanum or strontium in addition to these is particularly preferable.

The piezoelectric/electrostrictive layer may be dense or porous. When the piezoelectric/electrostrictive layer is porous, the void ratio is preferably 40% or less.

When an antiferroelectric layer is used as the emitter section 13, the antiferroelectric layer preferably contains lead zirconate as a main component, lead zirconate and lead stannate as main components, lead zirconate containing lanthanum oxide as an additive, or a lead zirconate and lead stannate containing lead niobate as an additive.

The antiferroelectric layer may be porous. When the antiferroelectric layer is porous, the void ratio thereof is preferably 30% or less.

In particular, strontium tantalate bismuthate (SrBi₂Ta₂O₉) is suitable for the emitter section, since it exhibits low fatigue by repeated polarization reversal. The material exhibiting low fatigue is a laminar ferroelectric compound represented by general formula (BiO₂)²⁺(Aₘ₋₁BₘO₃ₘ₊₁)²⁻. In the formula, the ions of the metal A are Ca²⁺, Sr²⁺, Ba²⁺, Pb²⁺, Bi³⁺, La³⁺, or the like, and the ions of the metal B are Ti⁴⁺, Ta⁵⁺, Nb⁵⁺, or the like. Alternatively, a piezoelectric ceramic based on barium titanate, lead zirconate, or PZT may be combined with an additive to impart semiconductive properties to the ceramic. In such a case, since the emitter section 13 provide an uneven electric field distribution, it becomes possible to concentrate the electric field near the boundary with the upper electrode that contributes to emit electrons.

The baking (firing) temperature of the emitter section 13 can be decreased by adding a glass component, such as lead borosilicate glass, or a low-melting-point compound (such as bismuth oxide) other than the glass component to the piezoelectric/electrostrictive/ferroelectric/antiferroelectric ceramic.

In forming the emitter section with the piezoelectric/electrostrictive/ferroelectric/antiferroelectric ceramic, the emitter section may be formed from a molded sheet, a laminated sheet, or a composite of the molded sheet or the laminated sheet stacked or bonded on a supporting substrate.

An emitter section that is hardly damaged by collision of electrons or ions can be produced by using a material having a high melting point or a high evaporation temperature, e.g., a non-lead material, for the emitter section.

The emitter section may be formed by various thick-film forming processes, such as a screen printing process, a dipping process, an application process, an electrophoresis process, and an aerosol deposition process, or by various thin-film forming processes, such as an ion-beam process, a sputtering process, a vacuum deposition process, an ion-plating process, a chemical vapor deposition (CVD) process, and a plating process. In particular, a powdered piezoelectric/electrostrictive material may be molded to form the emitter section, and the molded emitter section may be impregnated with a low-melting-point glass or sol particles to form a film at a temperature as low as 700° C. or 600° C. or less.

(Upper Electrode 14)

An organometal paste that can produce a thin film by firing (baking) is used to form the upper electrode. An example of the organ metal paste is a platinum resinate paste. The upper electrode is preferably made of an oxide that can decrease the fatigue due to polarization reversal or a platinum resinate paste containing an oxide for decreasing the fatigue by polarization reversal. Examples of the oxide that decreases the fatigue due to polarization reversal include ruthenium oxide (RuO₂), iridium oxide (IrO₂), strontium ruthenate (SrRuO₃), La₁₋ₓSrₓCoO₃ (e.g., x=0.3 or 0.5), La₁₋ₓCaₓMnO₃ (e.g., x=0.2), and La₁₋ₓCaₓMn_{1-y}CO_{y}O₃ (e.g., x=0.2, y=0.05).

Furthermore, preferably, the average diameter of the through-holes 14a of the upper is smaller than the grain size of the dielectric material of the emitter section 13. Furthermore, preferably, the upper electrode contains a metal, and the through-holes 14a are pores formed by crystal grains of the metal. The process of forming the upper electrode 14 and the materials of the upper electrode 14 will be described in detail below.

The upper electrode 14 is formed by extending an “organometallic compound containing at least two types of metals” of silver (Ag), gold (Au), iridium (Ir), rhodium (Rh), ruthenium (Ru), platinum (Pt), platinum (Pd), aluminum (Al), cupper (Cu), nickel (Ni), chromium (Cr), molybdenum (Mo), tungsten (W), and titanium (Ti) on the upper portion of the material forming the emitter section 13 in the shape of a film and baking the compound at a predetermined temperature.

Here, the “organometallic compound containing at least two types of metals” may be any of a compound formed by mixing two or more types of organometallic compounds containing only one type of metal, one type of organometallic compound containing two or more types of metals, and a compound formed by mixing one type of organometallic compound containing two or more types of meals with another organometallic compound. Further, preferably, the “organometallic compound containing at least two types of metals” may contain at least a noble metal. Furthermore, preferably, the noble metal may include platinum (Pt), gold (Au), or iridium (Ir).

### EXAMPLE 1

For example, one organometallic compound containing only one type of metal, i.e., Pt and another organometallic compound containing only one type of metal, i.e., Ir having the melting point higher than that of Pt are mixed with 97 percent by weight of Pt and 3 percent by weight of Ir (Pt:Ir=97:3). Then, the mixed organometallic compound paste is printed on the upper surface of the material forming the emitter section 13 by screen printing so as to be extended in the shape of a film, and is thereafter dried at a 100° C. temperature. Further, the formed compound is heated and temperature-increased to 700° C. with the temperature rise rate 47° C./min (47° C. per minute). The organometallic compound is kept in this state for 30 minutes to be baked (fired). By this process, the upper electrode 14 is manufactured. Alternatively, the mixture and agitation of 97 percent by weight of Pt and 3 percent by weight of Ir may be printed on the material forming the emitter section 13, then may be dried at 100° C., and may be temperature-increased to 700° C. with the temperature rise rate of 1400° C./min, may be kept in this state for 30 minutes to be manufactured (baked).

### EXAMPLE 2

One organometallic compound containing only one type of metal, i.e., Pt and another organometallic compound containing only one type of metal, i.e., Au having the melting point lower than that of Pt are mixed with 95 percent by weight of Pt and 5 percent by weight of Au (Pt:Au=95:5). Then, the mixed organometallic compound paste is printed on the upper surface of the material forming the emitter section 13 by screen printing, is extended in the shape of a film, and is thereafter dried at 100° C. Further, the formed compound is heated and temperature-increased to 650° C. with the temperature rise rate of 43° C./min (43° C. per minute) and is kept in this state for 30 minutes to be baked (fired). By this process, the upper electrode 14 can be preferably manufactured.

### EXAMPLE 3

The upper electrode 14 can be manufactured, containing three types of organometallic compounds. For example, one organometallic compound containing only one type of metal, i.e., Pt, serving as the base material, another organometallic compound containing only one type of metal, i.e., Au having the melting point lower than that of Pt, and another organometallic compound containing one type of metal, i.e., Ir having the melting point higher than that of Pt are mixed with 93 percent by weight of Pt, 4.5 percent by weight of Au, and 2.5 percent by weight of Ir. Then, the mixed organometallic compound paste is printed on the upper surface of the material forming the emitter section 13 by screen printing, is extended in the shape of a film, and is thereafter dried at 100° C. Further, the formed compound is heated and temperature-increased to 700° C. with the temperature rise rate of 47° C./min (47° C. per minute). The organometallic compound is kept in this state for 30 minutes and is baked (fired). By this process, the upper electrode can be preferably manufactured.

### EXAMPLE 4

The organometallic compound containing Pt, Au, and Ir as described above is printed on the upper surface of the material forming the emitter section 13 by screen printing, and is extended in the shape of a film. Thereafter, the compound is dried at a 100° C. temperature. Further, the formed compound is heated and temperature-increased to 700° C. with the temperature rise rate of 23° C./sec (23° C. per second, i.e., 1400° C. per minute). The organometallic compound is kept in this state for 30 minutes and is baked (fired). By this process, the upper electrode 14 can be manufactured.

### EXAMPLE 5

The upper electrode can be manufactured, containing only one type of metal as follows. For example, an organometallic compound paste containing only one type of metal, i.e., the above-mentioned predetermined metal (here, Pt) is printed on the upper surface of the material forming the emitter section 13 by screen printing, and is extended in the shape of film. Thereafter, the compound is dried at 100° C. Further, the formed compound is heated and temperature-increased to 600° C. with the temperature rise rate of 20° C./sec (20° C. per second, i.e., 1200° C. per minute). The organometallic compound is kept in this state for 30 minutes and is baked (fired).

The above-manufactured upper electrode 14 has an average diameter of the micro through hole 14a that is 10 nm or more and less than 100 nm, and thus a large amount of electrons can be emitted. As mentioned above, the average diameter of the micro through hole 14a may be 0.01 μm or more and 10 μm or less.

Further, the upper electrode may contain an aggregate of scale materials (e.g., black lead) or an aggregate of conductive materials including a scale material. The above-described material aggregate originally has a portion of separated scales. Therefore, such portion can be used as the micro through hole of the upper electrode without the baking (firing). Furthermore, organic resin and a metallic thin film are laminated on the emitter section in this order and the organic resin is thereafter baked to form the micro through holes in the metallic thin film, thereby forming the upper electrode.

The upper electrode may contain the above materials and may be formed by various thick-film forming processes, such as a screen printing process, a spraying process, a coating process, a dipping process, an application process, and an electrophoresis process, or by various typical thin-film forming processes, such as a sputtering process, an ion-beam process, a vacuum deposition process, anion-plating process, a chemical vapor deposition (CVD) process, and a plating process.

As is described above, the electron-emitting apparatus according to the present invention stepwise increases the drive voltage, thereby emitting the electrons a plurality of times, which are accumulated in the emitter section 13 by once electron-accumulation operation. Therefore, the inrush current does not flow through the electron-emitting element. Thus, the deterioration of the element due to the heat is prevented and the amount of emitted electrons can be increased.

Further, in the electron-emitting apparatuses, when the collector electrode 18 is earthed while unnecessary electron-emission may be emitted, and the collector voltage Vc is applied to the collector electrode 18 while the electron emission is required. Thus, each of the electron-emitting apparatus can impart sufficient energy to electrons properly emitted while avoiding unnecessary electron emission, and therefore, provide a display that can present satisfactory images. Moreover, even when the space between the upper electrode 14 and the collector electrode 18 enters a plasma state, the plasma can be eliminated since the collector electrode 18 is intermittently turned off. As a result, continuous generation of intense emission due to a continuing plasma state can be avoided.

In addition, the apparatus includes the focusing electrode. Thus, the distance between the upper electrode and the collector electrode can be increased since emitted electrons substantially travel in the right upward direction of the upper electrode. As a result, dielectric breakdown between the upper electrode and the collector electrode can be suppressed or avoided. Because the possibility of dielectric breakdown between the upper electrode and the collector electrode reduces, the first collector voltage V1 (Vc) applied to the collector electrode 18 during the period in which the collector electrode 18 is turned on can be increased. Thus, large energy can be imparted to the electrons reaching the phosphors, and the luminance of the display can be thereby increased.

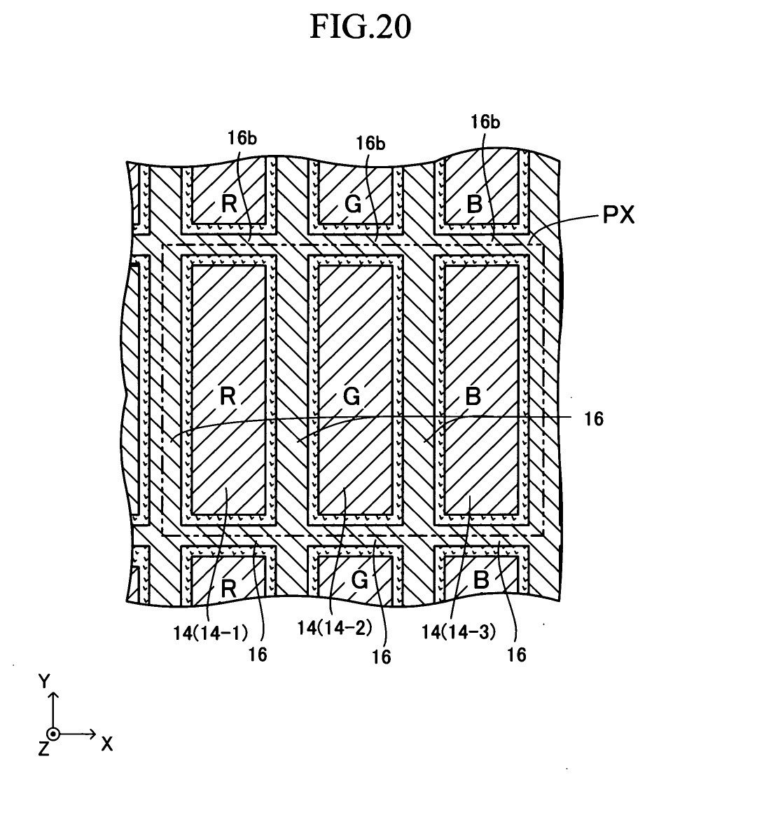

Note that the present invention is not limited to the embodiments described above and various other modifications and alternations can be adopted without departing from the scope of the invention. For example, the electron-emitting apparatus according to above described embodiments comprise a plurality of electron-emitting elements, however, the electron-emitting apparatus may comprise only one electron-emitting element. Further, for example, as shown in FIG. 20, the focusing electrodes 16 may be formed not only between the upper electrodes 14 adjacent to each other in the X-axis direction but also between the upper electrodes 14 adjacent to each other in the Y-axis direction in a plan view.

In addition, the phosphor may be in contact with the upper electrode 14 on the surface of the upper electrode 14 opposed to the emitter section 13. With this configuration, electrons emitted via the micro through holes 14a of the upper electrodes 14 collide with the phosphor disposed just on the top of the upper electrode 14, and the phosphor is excited to generates the light. Note that the above-mentioned phosphor as well as both the phosphors 19 and 19′ described in the embodiments are the “phosphors for emitting light by the collision of electrons, disposed to be opposed to the upper electrode 14 on the upper part of the upper electrode 14”.

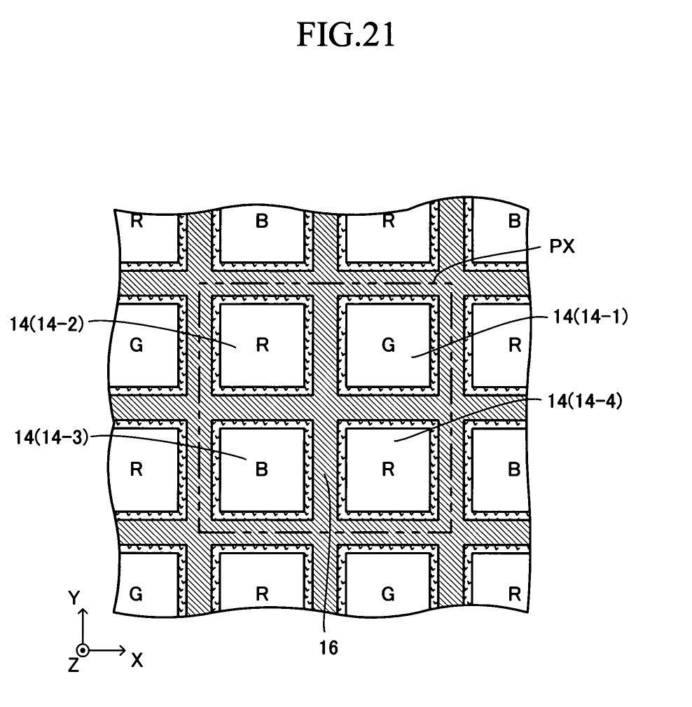

Furthermore, as shown in FIG. 21, one pixel PX of the electron-emitting apparatus may include four elements (a first upper electrode 14-1, a second upper electrode 14-2, a third upper electrode 14-3, and a fourth upper electrode 14-4), and focusing electrodes 16. In such a case, for example, a green phosphor (not shown) is disposed directly above the first upper electrode 14-1, a red phosphor (not shown) is disposed directly above each of the second upper electrode 14-2 and the fourth upper electrode 14-4, and a blue phosphor (not shown) is disposed directly above the third upper electrode 14-3. The focusing electrodes 16 are formed to surround each of the upper electrodes 14. With this arrangement, electrons emitted from the upper electrode 14 of a particular element reach only the phosphor disposed directly above the particular upper electrode 14. Thus, satisfactory color purity can be maintained, and blurring of the image patterns can be avoided.

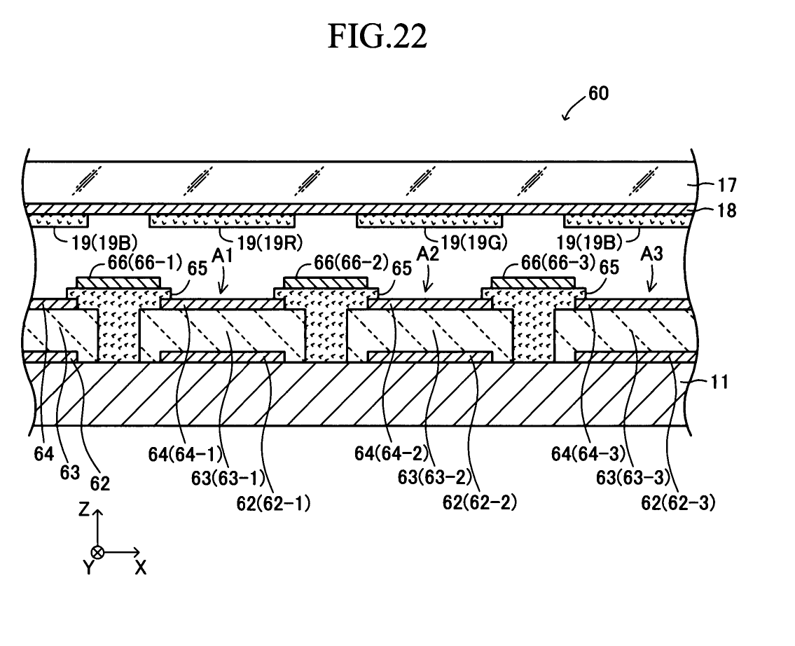

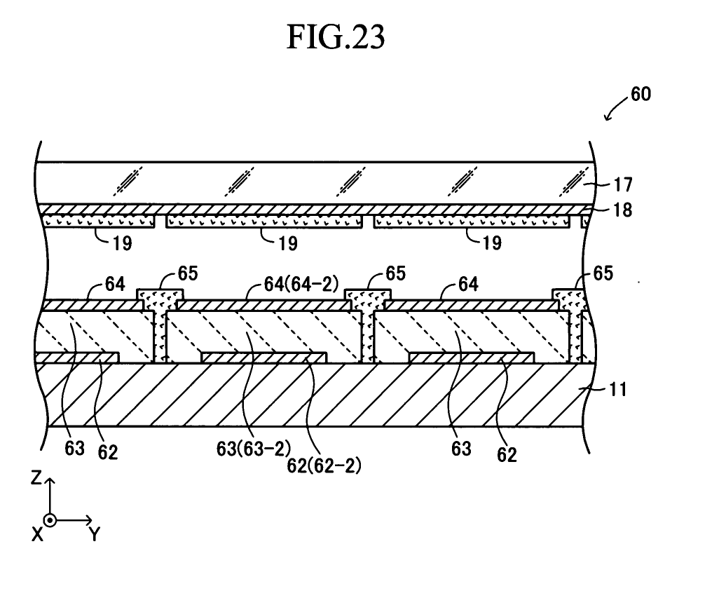

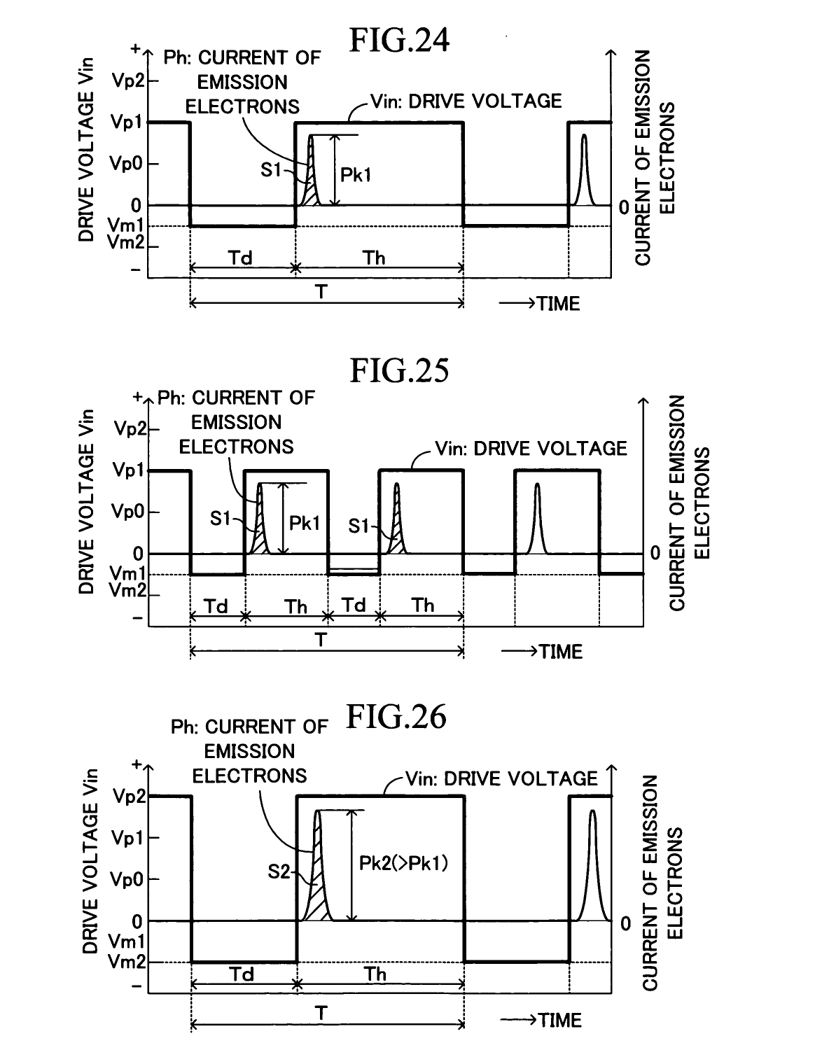

As shown in FIGS. 22 and 23, an electron-emitting apparatus 60 according to the present invention may include a plurality of completely independent elements aligned on the substrate 11, each element including a lower electrode 62, an emitter section 63, and an upper electrode 64. In this apparatus, the gaps between the elements may be filled with insulators 65, and the focusing electrodes 66 may be disposed on the upper surfaces of the insulators 65 between the upper electrodes 64 adjacent to each other in the X-axis direction. With the electron-emitting apparatus 60 having such a structure, electrons can be emitted from each of the elements either simultaneously or at independent timings.

The substrate 11 may be made of a material primarily containing aluminum oxide or a material primarily made of a mixture of aluminum oxide and zirconium oxide.

1. An electron-emitting apparatus comprising:
an element having:
an emitter section made of a dielectric material,
a lower electrode disposed below the emitter section, and
an upper electrode disposed above the emitter section to oppose the lower electrode, with the emitter section sandwiched therebetween, the upper electrode having a plurality of micro through holes and formed so that its surface around the circumference of the micro through holes facing the emitter section being apart from the emitter section,
wherein the element supplies electrons to the emitter section from the upper electrode when an element voltage which is a potential of the upper electrode relative to a potential of the lower electrode, is a negative voltage whose absolute value is larger than a predetermined level to accumulate the electrons in the emitter section, and emits the electrons accumulated in the emitter section via the micro through holes when the element voltage is a positive voltage whose absolute value is larger than another predetermined level while the electrons are accumulated in the emitter section; and
drive voltage applying means for applying a drive voltage between the upper electrode and the lower electrode to set the element voltage at the negative voltage and thereafter to set the element voltage at the positive voltage,
wherein the drive voltage applying means increases the positive voltage stepwise.

2. An electron-emitting apparatus according to claim 1, wherein the drive voltage applying means temporarily sets the element voltage at a voltage which is smaller than a first voltage and which does not cause the element to accumulate electrons in the emitter section, when increasing the positive voltage from the first voltage to a second voltage larger than the first voltage.

3. An electron-emitting apparatus according to claim 1, further comprising:
a phosphor which emits light by electron collision and which is disposed in the upper side of the upper electrode to oppose the upper electrode.

4. An electron-emitting apparatus according to claim 3, further comprising:
a collector electrode disposed near the phosphor; and
collector voltage applying means for applying a voltage to the collector electrode so that the collector electrode generates an electric field for collecting the emitted electrons toward the collector electrode side.

5. An electron-emitting method using an electron-emitting element having an emitter section made of a dielectric material, a lower electrode disposed below the emitter section, and an upper electrode disposed above the emitter section to oppose the lower electrode with the emitter section sandwiched therebetween, the upper electrode having a plurality of micro through holes and formed so that its surface around the circumference of the micro through holes facing the emitter section being apart from the emitter section, the electron-emitting method comprising the step of:
setting, at a negative voltage, an element voltage which is a potential of the upper electrode relative to a potential of the lower electrode, for supplying electrons to the emitter section from the upper electrode to accumulate the electrons in the emitter section, thereafter increasing the element voltage to a first positive voltage to emit via the micro through holes the electrons accumulated in the emitter section, then increasing the element voltage to a second positive voltage larger than the first voltage to emit via the micro through hole the electrons remaining in the emitter section.

6. An electron-emitting method according to claim 5, wherein the element voltage is temporarily set at a voltage which is smaller than the first voltage and which does not cause the element to accumulate electrons in the emitter section, when increasing the positive voltage from the first voltage to the second voltage larger than the first voltage.
